(19) United States
(12) Patent Application Publication
(10) Pub. No.: US 2008/0054716 A1
(43) Pub. Date: Mar. 6, 2008

(54) BRAKE CONTROL APPARATUS

(75) Inventors: Akihiro SATO, Yokohama (JP); Toshiyuki Innami, Ibaraki (JP); Hitoshi Kobayashi, Tokyo (JP); Katsuhiko Wakabayashi, Kanagawa (JP); Katsuya Iwasaki, Kanagawa (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/846,709

(22) Filed: Aug. 29, 2007

(30) Foreign Application Priority Data
Aug. 30, 2006 (JP) 2006-233265

(51) Int. Cl. B60T 7/12; F16D 65/14; G06F 7/70

(52) U.S. Cl. 303/16; 188/105; 701/70

(57) ABSTRACT

A brake control apparatus includes an actuator configured to generate a braking force of road wheel; a first control unit configured to calculate a target braking controlled variable in accordance with an amount of brake manipulation of a driver; and a second control unit including a backup calculation section configured to calculate a backup target braking controlled variable, by receiving the amount of brake manipulation separately from the first control unit. The second control unit selects one of the target braking controlled variable and the backup target braking controlled variable in accordance with operating conditions of the first control unit and the second control unit. The second control unit outputs a drive signal to the actuator so as to bring the braking force of road wheel closer to the selected one of the target braking controlled variable and the backup target braking controlled variable.

### BACKGROUND OF THE INVENTION

The present invention relates to a brake control apparatus adapted to control braking force, and specifically to a brake control apparatus capable of executing brake-by-wire (BBW) control.

Japanese Patent Application Publication No. 2002-187537 discloses a previously-proposed brake control apparatus. In this technique, target wheel-cylinder pressures are calculated based on the detected values of stroke sensor and master-cylinder pressure sensor, under the situation where the hydraulic communication between a brake pedal and wheel cylinders is shut off. By driving electromagnetic valves and a motor connected with pump on the basis of this target wheel-cylinder pressures, desired wheel-cylinder pressures are obtained. The brake control apparatus in this disclosure includes a first microcomputer that calculates target braking forces by receiving input signals of various sensors, and a second microcomputer provided separately from the first microcomputer as a backup. First and second microcomputers are connected respectively to different two of a drive circuit for electromagnetic valves for one pair of road wheels of vehicle in X-split layout, and a drive circuit for electromagnetic valves for another pair of road wheels in the X-split layout.

### SUMMARY OF THE INVENTION

However, in the above-described technique, the first microcomputer calculates the target braking force by receiving all the input signals of various sensors. Accordingly, there has been a possibility that the brake control becomes incapable of continuing when the first microcomputer becomes failed.

It is therefore an object of the present invention to provide brake control apparatus and method, devised to continuously execute a brake control even if a means of calculating a target braking controlled variable becomes failed.

According to one aspect of the present invention, there is provided a brake control apparatus comprising: an actuator configured to generate a braking force of road wheel; a first control unit configured to calculate a target braking controlled variable in accordance with an amount of brake manipulation of a driver; and a second control unit comprising a backup calculation section configured to calculate a backup target braking controlled variable, by receiving the amount of brake manipulation separately from the first control unit, the second control unit being configured to select one of the target braking controlled variable and the backup target braking controlled variable in accordance with operating conditions of the first control unit and the second control unit, the second control unit being configured to output a drive signal to the actuator so as to bring the braking force of road wheel closer to the selected one of the target braking controlled variable and the backup target braking controlled variable.

According to another aspect of the present invention, there is provided a brake control apparatus comprising: a master cylinder provided as a first fluid-pressure source; a first fluid passage adapted to allow a fluid pressure of the master cylinder to be applied via a first changeover valve to front-left and front-right wheel cylinders of a plurality of wheel cylinders; a second fluid passage connected with a second fluid-pressure source provided independently of the master cylinder, and adapted to apply a fluid pressure produced from the second fluid-pressure source via a second changeover valve directly to at least one of the plurality of wheel cylinders; and a control unit configured to switch between the fluid-pressure application from the master cylinder to the front-left and front-right wheel cylinders, and the fluid-pressure application from the second fluid-pressure source to the at least one of the plurality of wheel cylinders, by opening/closing the first changeover valve and the second changeover valve, the control unit comprising a first control unit configured to calculate a target braking controlled variable for obtaining a desired braking force, in accordance with an amount of brake manipulation of a driver; and a second control unit configured to calculate a backup target braking controlled variable separately from the first control unit, in accordance with the amount of brake manipulation, the second control unit being configured to select one of the target braking controlled variable and the backup target braking controlled variable in accordance with operating conditions of the first control unit and the second control unit, the second control unit being configured to output drive signals to the second fluid-pressure source and the first and second changeover valves, so as to bring a fluid pressure of the at least one of the plurality of wheel cylinders closer to a target fluid pressure based on the selected one of the target braking controlled variable and the backup target braking controlled variable.

According to still another aspect of the present invention, there is provided a brake control apparatus comprising: an electrical caliper provided at a road wheel and configured to be driven by a motor to generate a braking force of the road wheel; a first control unit configured to calculate a target braking controlled variable in accordance with an amount of brake manipulation of a driver; and a second control unit configured to calculate a backup target braking controlled variable, by receiving the amount of brake manipulation separately from the first control unit, the second control unit being configured to select one of the target braking controlled variable and the backup target braking controlled variable in accordance with operating conditions of the first control unit and the second control unit, the second control unit being configured to output a drive signal to the motor so as to bring the braking force of the road wheel closer to the selected one of the target braking controlled variable and the backup target braking controlled variable.

According to still another aspect of the present invention, there is provided a brake control method comprising the steps of: calculating a first target braking controlled variable in accordance with an amount of brake manipulation of a driver; calculating a second target braking controlled variable, by receiving the amount of brake manipulation separately from the calculation of the first target braking controlled variable; selecting one of the first target braking controlled variable and the second target braking controlled variable, in accordance with properness in the calculations of the first and second target braking controlled variables; and outputting a drive signal to an actuator that generates a braking force of road wheel, so as to bring the braking force of road wheel closer to the selected one of the first target braking controlled variable and the second target braking controlled variable.

The other objects and features of this invention will become understood from the following description with reference to the accompanying drawings.

### BRIEF DESCRIPTION OF THE DRAWINGS

FIG. 1 is a schematic system configuration view of a brake control apparatus in a first embodiment according to the present invention.

FIG. 2 is a schematic hydraulic circuit diagram of first hydraulic unit.

FIG. 3 is a schematic hydraulic circuit diagram of second hydraulic unit.

FIG. 4 is a schematic sectional view showing a structure of first hydraulic unit and first sub-ECU in the first embodiment.

FIG. 5 is a schematic block diagram showing a control configuration of brake-by-wire system in the first embodiment.

FIG. 6 is a flowchart showing a command-value calculating processing which is executed in main ECU in the first embodiment.

FIG. 7 is a flowchart showing a communication processing which is executed in main ECU in the first embodiment.

FIG. 8 is a flowchart showing a fluid-pressure control processing which is executed in first and second sub-ECUs in the first embodiment.

FIG. 9 is a flowchart showing a communication processing which is executed in first and second sub-ECUs in the first embodiment.

FIG. 10 is a flowchart showing a command-value judging processing which is executed in first and second sub-ECUs in the first embodiment.

FIG. 11 is a schematic system configuration view showing a brake-by-wire control system in a second embodiment according to the present invention.

FIG. 12 is a schematic block diagram showing a control configuration of brake-by-wire system in the second embodiment.

### DETAILED DESCRIPTION OF THE INVENTION

Reference will hereinafter be made to the drawings in order to facilitate a better understanding of the present invention. Embodiments according to the present invention will be explained in detail referring to the drawings.

### First Embodiment

[System Configuration]

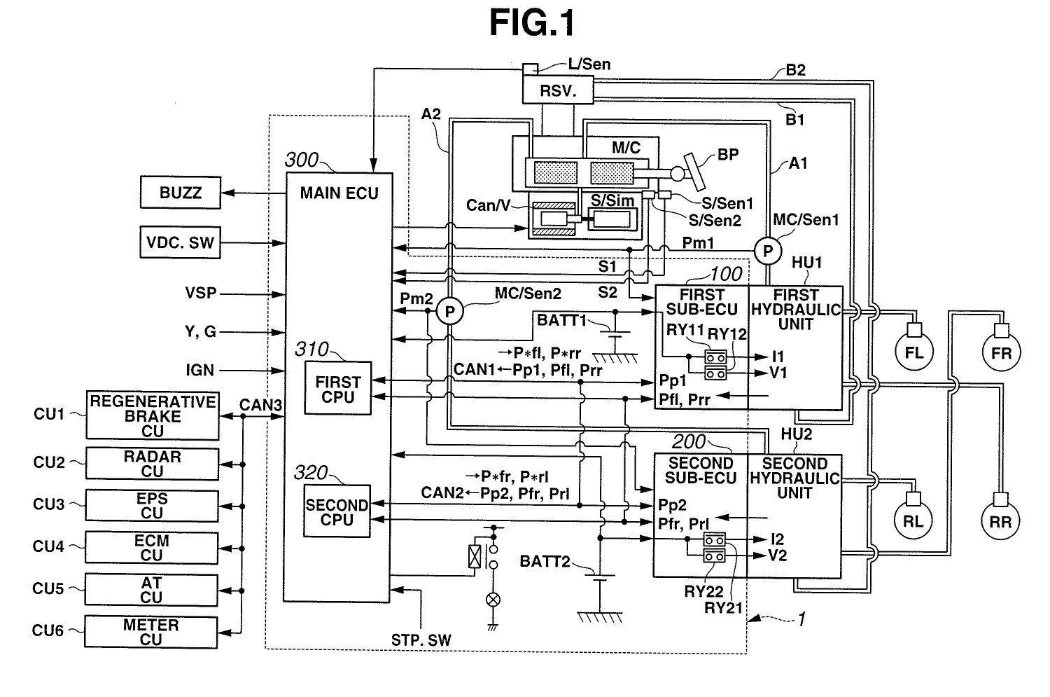

A system configuration according to a first embodiment of the present invention will now be explained referring to FIGS. 1 to 5. FIG. 1 is a schematic system configuration view of a brake control apparatus according to the first embodiment. The brake control apparatus according to the first embodiment is exemplified as a four-wheel brake-by-wire (BBM) system, and includes two of a first hydraulic unit HU1 and a second hydraulic unit HU2 capable of controlling or adjusting brake fluid pressures (wheel-brake cylinder pressures) independently of the manipulation of a brake pedal BP by a driver.

As shown in FIG. 1, a control unit 1 includes a main electronic control unit (main ECU) 300 and first and second sub-electronic control units (sub-ECUs) 100 and 200. Main ECU 300 (hereinafter also called “first control unit”) serves to calculate respective target wheel cylinder pressures P*fl, P*fr, P*rl, and P*rr for road wheels FL, FR, RL, and RR. First sub-ECU 100 serves to drive first hydraulic unit HU1, and second sub-ECU 200 serves to drive second hydraulic unit HU2 (each of first and second sub-ECUs 100 and 200 is hereinafter also called “second control unit”).

First and second hydraulic units HU1 and HU2 are respectively driven by first and second sub-ECUs 100 and 200 on the basis of commands derived from main ECU 300. A stroke simulator S/Sim connected with a master cylinder M/C applies reaction force to brake pedal BP.

First and second hydraulic units HU1 and HU2 are connected to master cylinder M/C respectively through fluid passages (oil lines) A1 and A2, and are connected to a reservoir RSV respectively through fluid passages B1 and B2. A first master-cylinder pressure sensor MC/Sen1 is provided in or screwed into fluid passage A1, and a second master-cylinder pressure sensor MC/Sen2 is provided in or screwed into fluid passage A2. First master-cylinder pressure sensor MC/Sen1 is mounted integrally in first hydraulic unit HU1, and similarly second master-cylinder pressure sensor MC/Sen2 is mounted integrally in second hydraulic unit HU2. The detailed explanations thereof will be mentioned below.

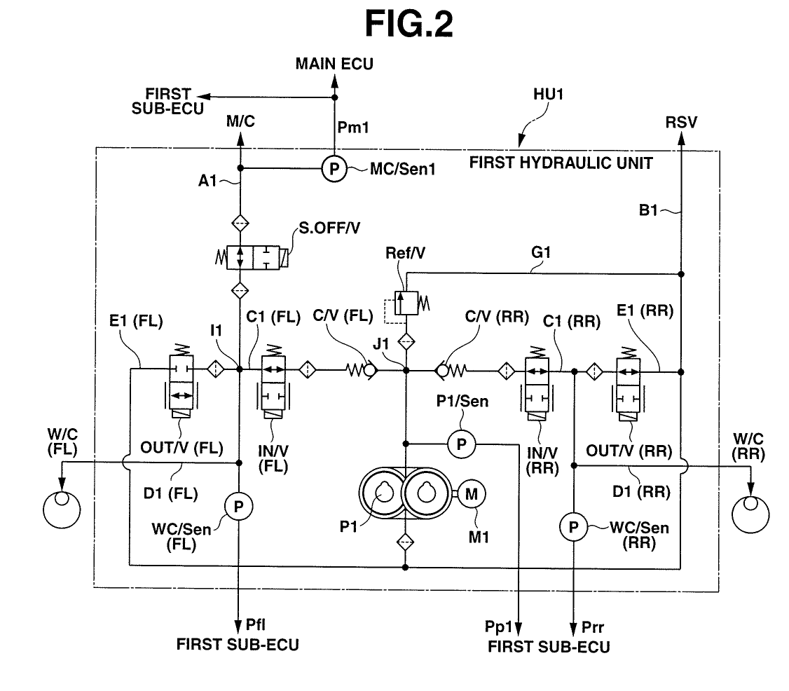

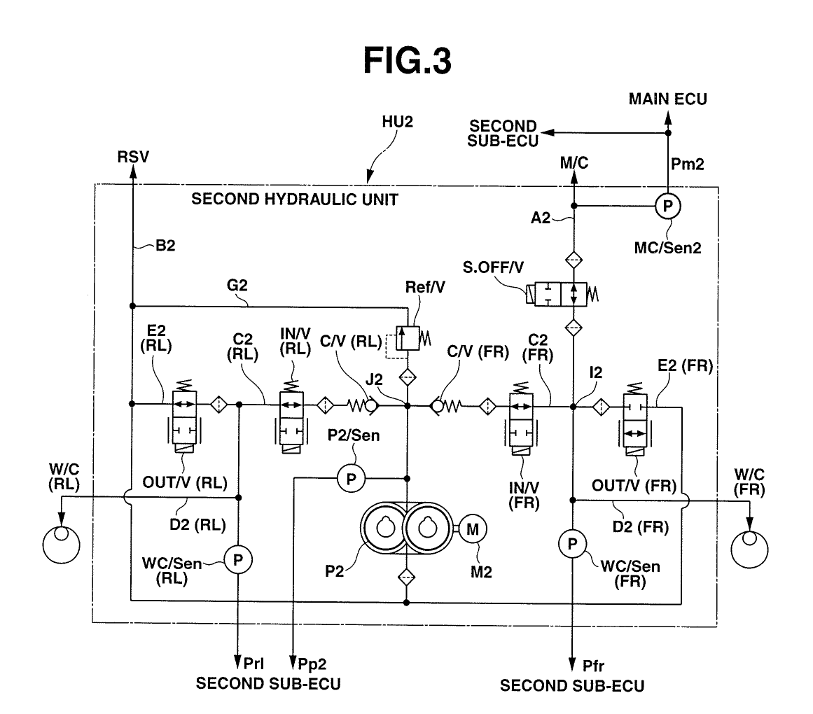

Moreover, as shown in FIG. 2, first hydraulic unit HU1 includes a gear-type pump P1, a motor M1, and solenoid (electromagnetic) valves. Similarly as shown in FIG. 3, second hydraulic unit HU2 includes a gear-type pump P2, a motor M2, and solenoid (electromagnetic) valves. Each of first and second hydraulic units HU1 and HU2 functions as a hydraulic actuator capable of generating fluid pressure (hydraulic pressure) independently. First hydraulic unit HU1 is adapted to perform the brake-fluid-pressure control for wheels FL and RR, and second hydraulic unit HU2 is adapted to perform the brake-fluid-pressure control for wheels FR and RL.

Namely, the fluid pressures of wheel cylinders W/C (FL˜RR) are increased or built up directly by gear-type pumps P1 and P2 serving as two fluid-pressure sources. Since each fluid pressure of wheel cylinder W/C is increased directly by first or second pump P1 or P2 without using any accumulator, there is no possibility that gas maintained inside the accumulator leaks into the fluid passages at the time of failed condition. As discussed above, first pump P1 functions to increase the cylinder pressures of a first pair of diagonally-opposed road wheels, namely, front-left and rear-right wheels FL and RR; and second pump P2 functions to increase the cylinder pressures of a second pair of diagonally-opposed road wheels, namely, front-right and rear-left wheels FR and RL. That is, pumps P1 and P2 are provided to construct a so-called diagonal split layout of brake circuits, sometimes termed “X-split layout”.

First and second hydraulic units HU1 and HU2 are configured to separate from each other. By use of the two separate hydraulic units HU1 and HU2; even if there is a leakage of working fluid from either one of first and second hydraulic units HU1 and HU2, it is possible to certainly produce a braking force by another not-failed hydraulic unit. Although first and second hydraulic units HU1 and HU2 are configured as separate units in this example, these hydraulic units HU1 and HU2 may be provided integral with each other. In such case, electric circuit configurations can be gathered to one place, and this contributes to shortened harness lengths, simplified brake system layout, and the like.

Recently, as a general layout of brake fluid passages (brake circuits) of vehicle, the so-called diagonal split layout (X-split layout or X-pipeline) is used. In the usual “X-split layout”, the diagonally-opposed wheels FL and RR (or FR and RL) are connected with each other by fluid passage. Namely, one of two different fluid-pressure sources (e.g., one output of tandem master cylinder) is connected via a first brake circuit to front-left and rear-right wheel cylinders W/C (FL) and W/C (RR), and another fluid-pressure source (e.g., another output of the tandem master cylinder) is connected via a second brake circuit to front-right and rear-left wheel cylinders W/C (FR) and W/C (RL), so as to be able to independently build up the first and second brake systems by means of the respective fluid-pressure sources (e.g., two-port outputs of the tandem master cylinder). By virtue of the use of X-split layout; for instance, assuming that the brake circuit associated with front-left wheel cylinder W/C (FL) is failed, the brake circuit associated with rear-right wheel cylinder W/C (RR) becomes failed simultaneously, and however the not-failed brake circuit (the second brake circuit) permits simultaneous braking force application to both of the front-right and rear-left road wheels. Conversely assuming that the brake circuit associated with front-right wheel cylinder W/C (FR) is failed, the brake circuit associated with rear-left wheel cylinder W/C (RL) becomes failed simultaneously, and however the not-failed brake circuit (the first brake circuit) permits simultaneous braking force application to both of the front-left and rear-right road wheels. Therefore, such X-split layout is superior in braking-force balance of vehicle even when either one of the first brake circuit (the first fluid-pressure source P1) associated with front-left and rear-right wheel cylinders W/C (FL) and W/C (RR) and the second brake circuit (the second fluid-pressure source P2) associated with front-right and rear-left wheel cylinders W/C (FR) and W/C (RL) is failed. The use of X-split layout contributes to the enhanced braking-force balance of vehicle.

Therefore, the brake control apparatus according to this embodiment is configured or designed to construct a dual fluid-pressure source system by way of first and second hydraulic units HU1 and HU2 having respective pumps P1 and P2 serving as two separate fluid-pressure sources, in order to enhance a fail-safe performance without changing the widespread or widely-used “X-split layout”.

[Main ECU]

Main ECU 300 is a broader central processing unit (CPU) that calculates target front-left wheel-cylinder pressure P*fl and target rear-right wheel-cylinder pressure P*rr for first hydraulic unit HU1 and also calculates target front-right wheel-cylinder pressure P*fr and target rear-left wheel-cylinder pressure P*rl for second hydraulic unit HU2. Main ECU 300 is connected to both of a first electric power source BATT1 and a second electric power source BATT2. Main ECU 300 can operate or work when at least one of power sources BATT1 and BATT2 is operating normally. Main ECU 300 is started responsively to an ignition switch signal IGN derived from an ignition switch, or responsively to an ECU starting requirement from each of control units CU1 to CU6. Each of control units CU1 to CU6 is connected through a controller area network (CAN) communications line CAN3 to main ECU 300.

Main ECU 300 receives a stroke signal S1 derived from a first stroke sensor S/Sen1, a stroke signal S2 derived from a second stroke sensor S/Sen2, a master-cylinder pressure signal derived from first master-cylinder pressure sensor MC/Sen1 which is indicative of a first master-cylinder pressure Pm1, and a master-cylinder pressure signal derived from second master-cylinder pressure sensor MC/Sen2 which is indicative of a second master-cylinder pressure Pm2. As used hereafter, first and second master-cylinder pressures Pm1 and Pm2 are collectively referred to as “master-cylinder pressure Pm”.

Main ECU 300 also receives a signal indicative of vehicle speed (wheel speed) VSP, a signal indicative of yaw rate Y, and a signal indicative of longitudinal acceleration G. Furthermore, main ECU 300 receives a sensor signal from a fluid quantity sensor L/Sen provided to reservoir RSV to detect a quantity of brake fluid of reservoir RSV. On the basis of the detected value of fluid quantity sensor L/Sen, it is determined whether or not brake-by-wire (BBW) control is executable by driving the pumps P1 and P2. Main ECU 300 also receives a signal from a stop lamp switch STP.SW, so as to detect a manipulation (depression) of brake pedal BP by the driver without using stroke sensor signals S1 and S2 and master-cylinder pressures Pm1 and Pm2.

Two central processing units (CPUs), namely first CPU 310 and second CPU 320, are provided in main ECU 300 for arithmetic calculations. First CPU 310 is defined as a main microcomputer (main microprocessor), and second CPU 320 is defined as a sub-microcomputer (sub-microprocessor) to construct a dual system. Thereby, these first and second CPUs 310 and 320 have a function of monitoring each other, so that fail-safe performance and safety performance of arithmetic device (microprocessor) are enhanced.

First CPU 310 is connected to first sub-ECU 100 via a CAN communications line CAN1, and second CPU 320 is connected to second sub-ECU 200 via a CAN communications line CAN2. Signals, respectively indicating a pump discharge pressure Pp1 discharged from first pump P1, and actual front-left and rear-right wheel-cylinder pressures Pfl and Prr, are inputted via first sub-ECU 100 into first CPU 310. Signals, respectively indicating a pump discharge pressure Pp2 discharged from second pump P2, and actual front-right and rear-left wheel-cylinder pressures Pfr and Prl, are inputted via second sub-ECU 200 into second CPU 320. Each of communications lines CAN1 and CAN2 is provided as a dual system for the purpose of backup, and these communications lines CAN1 and CAN2 are connected to each other.

On the basis of the input information such as stroke signals S1 and S2, master-cylinder pressures Pm1 and Pm2, and actual wheel-cylinder pressures Pfl, Pfr, Prl, and Prr; first CPU 310 calculates target front-left wheel-cylinder pressure P*fl and target rear-right wheel-cylinder pressure P*rr and outputs the calculated target wheel-cylinder pressures P*fl and P*rr via first CAN communications line CAN1 to first sub-ECU 100, while second CPU 320 calculates target front-right wheel-cylinder pressure P*fr and target rear-left wheel-cylinder pressure P*rl and outputs the calculated target wheel-cylinder pressures P*fr and P*rl via second CAN communications lines CAN2 to second sub-ECU 200.

In lieu thereof, first CPU 310 may calculate all the four target wheel-cylinder pressures P*fl to P*rr for first and second hydraulic units HU1 and HU2, whereas second CPU 320 may be used as a backup CPU for first CPU 310.

Main ECU 300 functions to start up each of first and second sub-ECUs 100 and 200 via CAN communications lines CAN1 and CAN2. In this embodiment, main ECU 300 generates two of a command signal for starting up sub-ECU 100 and a command signal for starting up sub-ECU 200 independently of each other. In lieu thereof, sub-ECUs 100 and 200 may be started up simultaneously in response to a single command signal from main ECU 300. Alternatively, sub-ECUs 100 and 200 may be started up simultaneously in response to the ignition switch signal IGN.

During execution of vehicle dynamic-behavior control including anti-skid brake control (often abbreviated to “ABS”, which is executed for increasing or decreasing a braking force for wheel-lock prevention), vehicle dynamics control (often abbreviated to “VDC”, which is executed for increasing or decreasing a braking force to prevent side slip occurring due to instable vehicle behaviors), traction control (often abbreviated to “TCS”, which is executed for acceleration-slip suppression of drive wheels), and the like; input information such as vehicle speed VSP, yaw rate Y, and longitudinal acceleration G is further extracted for executing the fluid-pressure control concerning target wheel-cylinder pressures P*fl, P*fr, P*rl, and P*rr. During the vehicle dynamics control (VDC), a warning buzzer BUZZ emits a buzzing sound cyclically to warn the driver or vehicle occupants that the VDC system comes into operation. A VDC switch VDC.SW serving as a man-machine interface is also provided so as to manually engage or disengage the VDC function in accordance with the driver's wishes.

Main ECU 300 is also connected to the other control units CU1 to CU6 via the CAN communications line CAN3 for cooperative control. For energy regeneration, the regenerative brake control unit CU1 is provided to return a braking force to an electric supply system by way of conversion from kinetic energy into electric energy. The radar control unit CU2 is provided for vehicle-to-vehicle distance control. The EPS control unit CU3 serves as a control unit for an electrically-operated (motor-driven) power steering system.

The ECM control unit CU4 is an engine control unit, the At control unit CU5 is an control unit for automatic transmission, and the meter control unit CU6 is provided to control each of meters. The information indicative of vehicle speed VSP inputted into main ECU 300 is outputted via the CAN communications line CAN3 to each of ECM control unit CU4, AT control unit CU5, and meter control unit CU6.

First and second power sources BATT1 and BATT2 correspond to electric power sources for ECUs 100, 200, and 300. Concretely, first power source BATT1 is connected to main ECU 300 and first sub-ECU 100, and second power source BATT2 is connected to main ECU 300 and second sub-ECU 200.

[Sub-ECU]

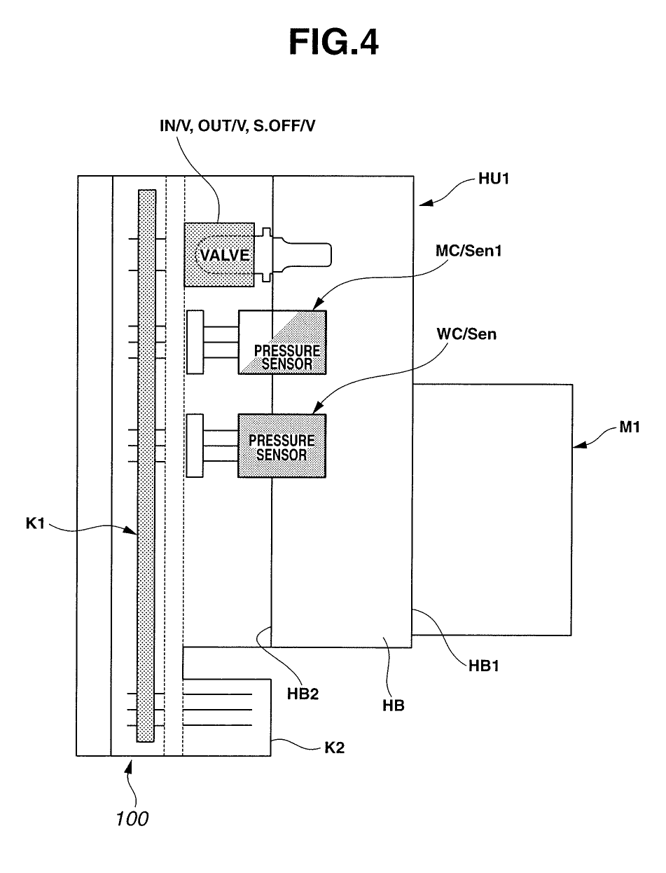

In this embodiment, first sub-ECU 100 is formed integral with first hydraulic unit HU1, and similarly second sub-ECU 200 is formed integral with second hydraulic unit HU2. FIG. 4 is a schematic sectional view showing a structure of first hydraulic unit HU1 and first sub-ECU 100. First hydraulic unit HU1 is composed of an aluminum housing block HB which is in the shape of substantially rectangular parallelepiped. Inside this aluminum housing block HB, there are provided a plurality of fluid passages formed to drill or pierce in housing block HB. Motor M1 is mounted on a first side surface HB1 of housing block HB. First master-cylinder pressure sensor MC/Sen1 and a wheel-cylinder pressure sensor WC/Sen are fixed to be pressed in a second side surface HB2 opposite to first side surface HB1. A plurality of solenoid (electromagnetic) valves IN/V, OUT/V, and S.OFF/V are also mounted in second side surface HB2.

On the side of this second side surface HB2, a circuit board K1 of first sub-ECU 100 is attached to housing block HB at a position opposed to second side surface HB2. Namely, circuit board KS is mounted so as to face the second side surface HB2. (Connecting) Terminals of the respective pressure sensors and electromagnetic valves are connected with circuit board KS to attach together by means of melting (e.g., soldering or welding). At one end portion of circuit board K1 (on a lower portion of circuit board K1 as viewed in FIG. 4), first sub-ECU 100 includes a connector portion K2 for connecting the circuit board K1 with the CAN communications lines, power sources, and the like.

As mentioned above, since first sub-ECU 100 is provided integral with first hydraulic unit HU1 (integral with the drive circuits for driving respective electromagnetic valves and motor M1), it is unnecessary to use harnesses for communicating first sub-ECU 100 to first hydraulic unit HU1. Accordingly, a downsizing (miniaturization) in control system can improve a flexibility in layout.

Here, a basic structure of (second hydraulic unit HU2 +second sub-ECU 200) is in common with the basic structure of (first hydraulic unit HU1 +first sub-ECU 100), and therefore explanations about the structure of second hydraulic unit HU2 and second sub-ECU 200 will be omitted.

First sub-ECU 100 receives input information signals indicating the target wheel-cylinder pressures P*fl to P*rr which are outputted or generated from main ECU 300, and also receives input informational signals indicating the pump discharge pressure Pp1 discharged from first pump P1, actual front-left and rear-right wheel-cylinder pressures Pfl and Prr, and the master-cylinder pressure derived from first master-cylinder pressure sensor MC/Sen1 which are outputted or generated from first hydraulic unit HU1. In the similar manner, second sub-ECU 200 receives input information signals indicating target wheel-cylinder pressures P*fl to P*rr which are outputted or generated from main ECU 300, and also receives input informational signals indicating pump discharge pressure Pp2 discharged from second pump P2, actual front-right and rear-left wheel-cylinder pressures Pfr and Prl, and the master-cylinder pressure derived from second master-cylinder pressure sensor MC/Sen2 which are outputted or generated from second hydraulic unit HU2.

Each of first and second sub-ECUs 100 and 200 includes a backup calculation section serving to briefly (simply) calculate backup target wheel-cylinder pressures on the basis of the master-cylinder pressure, separately from target wheel-cylinder pressures P*fl to P*rr calculated by main ECU 300. A configuration of this backup calculation section will be explained below.

On the basis of the latest up-to-date informational data (more recent data) about pump discharge pressures Pp1 and Pp2 and actual wheel-cylinder pressures Pfl to Prr, the fluid-pressure control is performed to realize target wheel-cylinder pressures P*fl to P*rr (or backup target wheel-cylinder pressures, as target controlled variables) by driving the electromagnetic valves and motors M1 and M2 for pumps P1 and P2 incorporated in respective hydraulic units HU1 and HU2.

The above-mentioned first sub-ECU 100 constructs a servo control system that continuously executes fluid-pressure control for front-left and rear-right wheels FL and RR, based on the inputted values concerning target wheel-cylinder pressure P*fl and P*rr in such a manner as to bring actual wheel-cylinder pressures Pfl and Prr closer to these inputted values (i.e., as to cause pressures Pfl and Prr to converge to these inputted values), until new target values are inputted. In the similar manner, the above-mentioned second sub-ECU 200 constructs a servo control system that continuously executes fluid-pressure control for front-right and rear-left wheels FR and RL, based on the inputted values concerning target wheel-cylinder pressure P*fr and P*rl in such a manner as to bring actual wheel-cylinder pressures Pfr and Prl closer to these inputted values, until new target values are inputted.

By means of first sub-ECU 100, electric power from first power source BATT1 is converted into a valve driving current I1 and a motor driving voltage V1 for first hydraulic unit HU1, and then the converted valve driving current I1 and motor driving voltage V1 are relayed or outputted through respective relays RY11 and RY12 to first hydraulic unit HU1. In the similar manner, by means of second sub-ECU 200, electric power from second power source BATT2 is converted into a valve driving current I2 and a motor driving voltage V2 for second hydraulic unit HU2, and then the converted valve driving current I2 and motor driving voltage V2 are relayed or outputted through respective relays RY21 and RY22 to second hydraulic unit HU2.

[Target Value Calculation for Hydraulic Unit and Driving Current/Voltage Control, separated from each other]

As discussed above, main ECU 300 is configured to execute arithmetic processing for target values P*fl to P*rr for first and second hydraulic units HU1 and HU2, but not configured to execute the above-mentioned driving current/voltage control concerning the valve driving currents I1 and I2 and motor driving voltages V1 and V2. Assuming that main ECU 300 is configured to execute the driving current/voltage control as well as the target wheel-cylinder pressure calculations, main ECU 300 must output driving commands to first and second hydraulic units HU1 and HU2 in accordance with cooperative control with the other control units CU1 to CU6 by way of controller area network (CAN) communications and the like.

In such a case, target wheel-cylinder pressures P*fl to P*rr are outputted after the arithmetic operations of CAN communications line CAN3 and of the other control units CU1 to CU6 have terminated. On the assumption that a transmission speed of CAN communications line CAN3 and operation speeds of the other control units CU1 to CU6 are slow, there is an undesirable response delay in fluid-pressure control (brake control).

One way to avoid such undesirable response delay is to increase the transmission speed of each of communications lines needed for connections with the other controllers installed inside the vehicle. However, this leads to another problem of increased costs. Additionally, a deterioration in fail-safe performance occurs owing to noise caused by the increased transmission speed.

For the reasons discussed above, in this embodiment, the role of main ECU 300 in fluid-pressure control is limited to the arithmetic operations of target wheel-cylinder pressures P*fl to P*rr. Namely, the driving control for first and second hydraulic unit HU1 and HU2 (hydraulic actuators) is performed by first and second sub-ECUs 100 and 200 each including servo control system.

With the above-mentioned arrangement, first and second sub-ECUs 100 and 200 specialize in the driving control for first and second hydraulic units HU1 and HU2, while the cooperative control with the other control units CU1 to CU6 is performed by main ECU 300. Thus, it becomes possible to execute the fluid-pressure control (brake control) without being affected by several factors, i.e., the transmission speed of CAN communications line CAN3 and the operation speeds of control units CU1 to CU6. The above-mentioned backup calculation which is executed in each of first and second sub-ECUs 100 and 200 does not include complex arithmetic, namely is executed relatively simply on the basis of master-cylinder pressure. Hence, this backup calculation does not increase a load in arithmetic processing that much.

Therefore, even when integrated controllers (units) for a regenerative cooperative brake system necessary for a hybrid vehicle (HV) or a fuel-cell vehicle (FCV), an integrated vehicle control system, and/or an intelligent transport system (ITS) are further added; it is possible to ensure or realize a high brake control responsiveness while smoothly planning a fusion with these additional units/systems, by independently controlling the brake control system separately from the other control systems.

The brake control apparatus equipped with BBW system as this embodiment, requires a precise fluid-pressure control suited to a manipulated variable (a depression stroke) of brake pedal BP, during normal braking operations which occur frequently. Thus, separating arithmetic operations of target wheel-cylinder pressures P*fl to P*rr for hydraulic units HU1 and HU2 from the driving control for hydraulic units HU1 and HU2 is more effective and advantageous.

However, from a view point of fail-safe performance, it is not favorable that the target wheel-cylinder pressures cannot be calculated in the case where main ECU 300 becomes in some failed condition. Therefore, the brake control apparatus in this embodiment is designed to ensure a normally-minimum-necessary (backup) braking force by means of first and second sub-ECUs 100 and 200 even when main ECU 300 is in failed condition, although the complex cooperative control or vehicle dynamic-behavior control is consistently performed by main ECU 300. Concretely, first and second sub-ECUs 100 and 200 perform the backup calculation for target wheel-cylinder pressures. Thus, the braking-force control according to the master-cylinder pressure can be continued by first and second sub-ECUs 100 and 200 if main ECU 300 becomes failed.

The brake control apparatus in this first embodiment is equipped with a mechanical backup system (manual brake circuit) that connects master cylinder MC with wheel cylinders WC in the case where some trouble occurs in the brake-by-wire (BBW) control system. However, it is difficult to secure a sufficient braking force, since this mechanical backup system generates only wheel-cylinder pressures directly according to the depression force applied by the driver.

At this time, by means of the above-mentioned backup calculation of first and second sub-ECUs 100 and 200, the simplified (backup) brake-by-wire control becomes executable. Thereby, it is possible to secure sufficient braking force even if the depression force of driver is weak.

[Master Cylinder and Stroke Simulator]

Stroke simulator S/Sim is built in master cylinder M/C and provided to generate a reaction force of brake pedal BP. Also in master cylinder M/C, there is provided a stroke-simulator cutoff valve Can/V for establishing or blocking fluid communication between master cylinder M/C and stroke simulator S/Sim.

Opening and closing operation of stroke-simulator cutoff valve Can/V is controlled by means of main ECU 300, such that the rapid switching to a manual brake mode can occur upon the termination of brake-by-wire control or when sub-ECUs 100 and 200 become failed. As described above, first and second stroke sensors S/Sen1 and S/Sen2 are provided at master cylinder M/C. Two stroke signals S1 and S2 each indicating the stroke of brake pedal BP are generated from respective stroke sensors S/Sen1 and S/Sen2 to main ECU 300.

[Hydraulic Unit]

FIG. 2 is a schematic hydraulic circuit diagram of first hydraulic unit HU1. Components incorporated in first hydraulic unit HU1 are electromagnetic valves (directional control valves or changeover valves), pump P1, check valves C/V, and motor M1. The electromagnetic valves include a shutoff valve S.OFF/V, a front-left inflow valve IN/V(FL), a rear-right inflow valve IN/V(RR), a front-left outflow valve OUT/V(FL), and a rear-right outflow valve OUT/V(RR).

A discharge line (a pump outlet side) of pump P1 is connected through a fluid passage C1(FL) to the front-left wheel cylinder W/C(FL), and is also connected through a fluid passage C1(RR) to the rear-right wheel cylinder W/C(RR). A suction line (a pump inlet side) of pump P1 is connected through a fluid passage B1 to reservoir RSV. Fluid passage C1(FL) is connected through a fluid passage E1(FL) to fluid passage B1, and similarly the fluid passage C1(RR) is connected through a fluid passage E1(RR) to fluid passage B1.

A joining point I1 of fluid passage C1(FL) and fluid passage E1(FL) is connected through fluid passage A1 to master cylinder M/C. Furthermore, a joining point J1 of fluid passage C1(FL) and fluid passage C1(RR) is connected through a fluid passage G1 to fluid passage B1.

Shutoff valve S.OFF/V is a normally-open electromagnetic valve, and fluidly disposed in fluid passage A1 for establishing or blocking fluid communication between master cylinder M/C and joining point I1.

Front-left inflow valve IN/V(FL) is fluidly disposed in fluid passage C1(FL), and is a normally-open proportional control valve that regulates the discharge pressure produced by pump P1 by way of proportional control action and then supplies the proportional-controlled fluid pressure to front-left wheel cylinder W/C(FL). Similarly, front-right inflow valve IN/V(RR) is disposed in fluid passage C1(RR), and is a normally-open proportional control valve that regulates the discharge pressure produced by pump P1 by way of proportional control action and then supplies the proportional-controlled fluid pressure to rear-right wheel cylinder W/C(RR).

Moreover, backflow-prevention check valves C/V(FL) and C/V(RR) are fluidly disposed in respective fluid passages C1(FL) and C1(RR) to prevent working fluid from flowing back to the discharge port of pump P1. These backflow-prevention check valves serve to reduce an electric power consumption by always blocking or shutting off the fluid flow from the road-wheel cylinder side toward the discharge port of pump P1. Furthermore as a matter of course, these backflow-prevention check valves prevent master-cylinder pressure Pm from acting on the discharge side of pump P1 at the time of above-mentioned failed condition.

Front-left and rear-right outflow valves OUT/V(FL) and OUT/V(RR) are fluidly disposed in respective fluid passages E1(FL) and E1(RR). Front-left outflow valve OUT/V(FL) is a normally-closed proportional control valve, whereas rear-right outflow valve OUT/V(RR) is a normally-open proportional control valve. A relief valve Ref/V is fluidly disposed in fluid passage G1.

First M/C pressure sensor MC/Sen1 is provided in or screwed into fluid passage A1 interconnecting first hydraulic unit HU1 and master cylinder M/C, for detecting first master-cylinder pressure Pm1 and for outputting a signal indicative of the detected first master-cylinder pressure to main ECU 300. Front-left and rear-right wheel-cylinder pressure sensors WC/Sen(FL) and WC/Sen(RR) are incorporated into first hydraulic unit HU1 and provided in or screwed into respective fluid passages C1(FL) and C1(RR), for detecting actual front-left and rear-right wheel-cylinder pressures Pfl and Prr. A first pump discharge pressure sensor P1/Sen is provided in or screwed into the discharge passage of pump P1, for detecting the discharge pressure Pp1 discharged from first pump P1. Signals indicative of the detected values Pfl, Prr, and Pp1 are outputted from the respective sensors WC/Sen(FL), WC/Sen(RR), and P1/Sen to first sub-ECU 100.

Alternatively, first master-cylinder pressure Pm1 may be outputted to first sub-ECU 100, and then outputted from first sub-ECU 100 through one or both of lines CAN1 and CAN2 to main ECU 300.

[Normal Braking]

(During Pressure Buildup)

During normal braking at a pressure buildup mode (increase mode); shutoff valve S.OFF/V is kept closed, inflow valves IN/V(FL) and IN/V(RR) are kept open, outflow valves OUT/V(FL) and OUT/V(RR) are kept closed, and motor M1 is rotated or driven. Pump P1 is driven by motor M1, and thus a discharge pressure from pump P1 is supplied to fluid passages C1(FL) and C1(RR). Then, the regulated working fluid, proportional-controlled by front-left inflow valve IN/V(FL), is introduced from inflow valve IN/V(FL) via a fluid passage D1(FL) into front-left wheel cylinder W/C(FL). Likewise, the regulated working fluid, proportional-controlled by rear-right inflow valve IN/V(RR), is introduced from inflow valve IN/V(RR) via a fluid passage D1(RR) into rear-right wheel cylinder W/C(RR). In this manner, the pressure buildup of wheel cylinders can be achieved. Alternatively, the pressure buildup may be conducted directly by regulating the discharge pressure of pump by means of motor driving control.

(During Pressure Reduction)

During normal braking at a pressure reduction mode, inflow valves IN/V(FL) and IN/V(RR) are kept closed (may be kept open because of the function of check valves C/V), while outflow valves OUT/V(FL) and OUT/V(RR) are kept open. Thus, front-left and rear-right wheel-cylinder pressures Pfl and Prr, namely working fluids in front-left and rear-right wheel cylinders W/C(FL) and W/C(RR) are exhausted through outflow valves OUT/V(FL) and OUT/V(RR) via fluid passage B1 into reservoir RSV. In this manner, the pressure reduction of wheel cylinders can be achieved.

(During Pressure Hold)

During normal braking at a pressure hold mode, inflow valves IN/V(FL) and IN/V(RR) and outflow valves OUT/V(FL) and OUT/V(RR) are all kept closed, so as to hold or retain front-left and rear-right wheel-cylinder pressures Pfl and Prr unchanged.

[Manual Brake]

When the operating mode of BBW-system-equipped brake control apparatus has been switched to the manual brake mode due to a system failure or the like; shutoff valve S.OFF/V becomes open, and inflow valves IN/V(FL) and IN/V(RR) become open (but in closed state as viewed from the side of master cylinder MC because of the function of check valve C/V). As a result of this, master-cylinder pressure Pm is not delivered to rear-right wheel-cylinder W/C(RR).

On the other hand, front-left outflow valve OUT/V(FL) is a normally-closed valve and therefore is kept closed during the manual brake mode. Accordingly, master-cylinder pressure Pm is being applied to front-left wheel cylinder W/C(FL) during the manual brake mode. Thus, master-cylinder pressure Pm built up by the driver's brake-pedal depression is applied to front-left wheel cylinder W/C(FL). In this manner, the manual brake operation can be achieved or ensured.

Suppose that master-cylinder pressure Pm is applied to rear-right wheel cylinder W/C(RR) as well as front-left wheel cylinder W/C(FL) during the manual brake mode. In such case, when building up rear-right wheel-cylinder pressure Prr as well as front-left wheel-cylinder pressure Pfl by leg-power by the driver's foot (pedal depression power), there is a problem of unnatural feeling that the driver experiences an excessive leg-power load. This is not realistic. For this reason, during the manual brake mode, the brake system in this embodiment is configured to apply master-cylinder pressure Pm (namely, manual braking) only to front-left road wheel FL which can generate a relatively great braking force in comparison with rear-right road wheel RR in first hydraulic unit HU1. Therefore, rear-right outflow valve OUT/V(RR) is constructed as a normally-open valve, for rapidly exhausting the residual pressure in rear-right wheel cylinder W/C(RR) into reservoir RSV to avoid undesirable rear-right wheel lockup at the time of system failure (such as BBW system failure or battery failure).

FIG. 3 is a schematic hydraulic circuit diagram of second hydraulic unit HU2. Components incorporated in second hydraulic unit HU2 are electromagnetic valves, check valves C/V, pump P2, and motor M2. The electromagnetic valves include a shutoff valve S.OFF/V, a front-right inflow valve IN/V(FR), a rear-left inflow valve IN/V(RL), a front-right outflow valve OUT/V(FR), and a rear-left outflow valve OUT/V(RL). The hydraulic circuit configurations and control operations are same in both first and second hydraulic units Hu1 and HU2. In explaining the second hydraulic unit HU2, for the purpose of simplification of the disclosure, detailed descriptions of the similar components will be omitted because the above description thereon seems to be self-explanatory. In the similar manner to first hydraulic unit HU1, regarding second hydraulic unit HU2, front-right outflow valve OUT/V(FR) is a normally-closed proportional control valve, whereas rear-left outflow valve OUT/V(RL) is a normally-open proportional control valve. For second hydraulic unit HU2 during the manual brake mode, the brake system in this embodiment is configured to apply master-cylinder pressure Pm only to front-right road wheel FR which generates a relatively great braking force in comparison with rear-left road wheel RL. As mentioned above, rear-left outflow valve OUT/V(RL) is constructed as a normally-open valve, for rapidly exhausting the residual pressure inside rear-left wheel cylinder W/C(RL) into reservoir RSV and for avoiding undesirable rear-left wheel lockup.

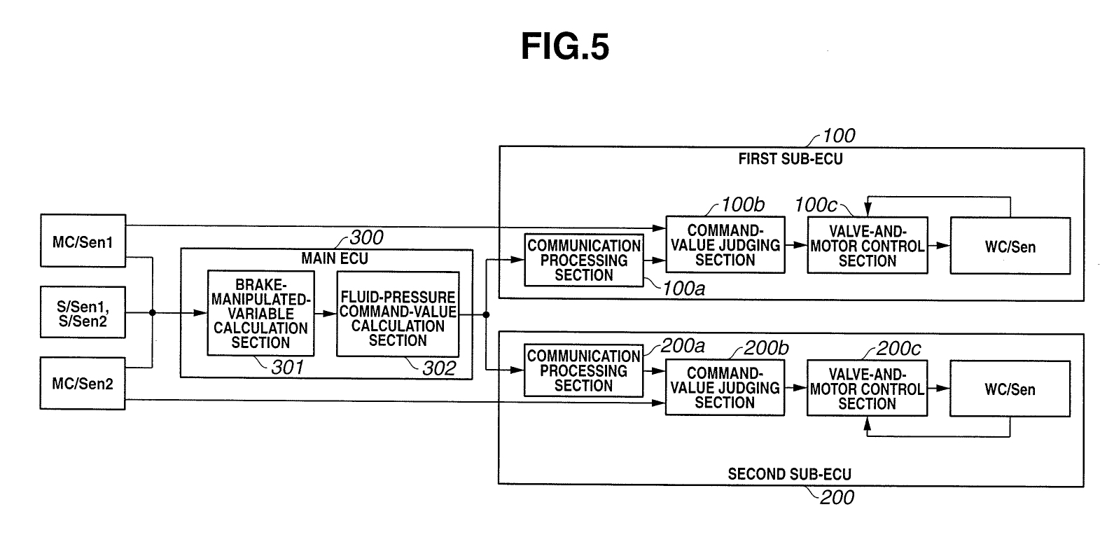

FIG. 5 is a schematic block diagram showing the control configuration of brake-by-wire (BBW) system in the first embodiment. As shown in FIG. 5, main ECU 300 includes a brake-manipulated-variable calculation section 301 and a fluid-pressure command-value calculation section 302. Brake-manipulated-variable calculation section 301 calculates the brake manipulated variable of driver (manipulation quantity, i.e., the depression stroke amount of brake pedal or an amount corresponding to the state of brake manipulation such as the master-cylinder pressure) from each sensor signal. Fluid-pressure command-value calculation section 302 calculates target wheel-cylinder pressures P*fl, P*fr, P*rl, and P*rr as fluid-pressure command values for respective wheels on the basis of the calculated brake manipulated variable. Target wheel-cylinder pressures P*fl to P*rr calculated by fluid-pressure command-value calculation section 302 are transmitted to first and second sub-ECUs 100 and 200.

First sub-ECU 100 includes a communication processing section 100a serving to carry out a communication processing for the communication with main ECU 300.

First sub-ECU 100 further includes a command-value judging section 100b and a valve-and-motor control section 100c. Command-value judging section 100b calculates the backup target wheel-cylinder pressures in accordance with first master-cylinder pressure sensor MC/Sen1, and determines final target wheel-cylinder pressures by judging or checking the calculated backup target wheel-cylinder pressures in comparison with target wheel-cylinder pressures P*fl to P*rr transmitted from main ECU 300. Valve-and-motor control section 100c controls the respective electromagnetic valves and motor M1 to achieve the final target wheel-cylinder pressures, on the basis of signals of wheel-cylinder pressure sensors WC/Sen(FL) and WC/Sen(RR).

Second sub-ECU 200 includes a communication processing section 200a, a command-value judging section 200b, and a valve-and-motor control section 200c, in the same manner as first sub-ECU 100.

[Brake-By-Wire Control Processing]

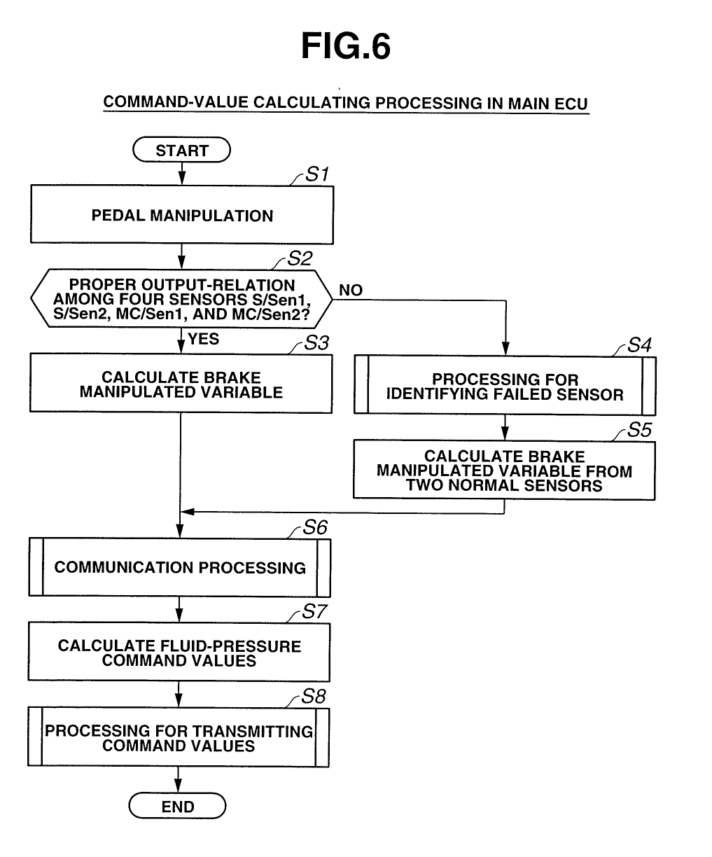

FIGS. 6 to 10 are flowcharts showing routines of the brake-by-wire control processing which is executed within main ECU 300 and first and second sub-ECUs 100 and 200.

(Command-value Calculating Processing in Main ECU)

FIG. 6 is a flowchart showing a command-value calculating processing executed in main ECU 300.

At step S1, main ECU 300 detects a brake pedal manipulation by the driver, on the basis of sensed values of first and second stroke sensors S/Sen1 and S/Sen2.

At step S2, main ECU 300 judges whether or not there is a proper output-relation between the sensed values of first and second stroke sensors S/Sen1 and S/Sen2 and the sensed values of first and second master-cylinder pressure sensors MC/Sen1 and MC/Sen2. If there is the proper output-relation; main ECU 300 determines that the sensors have no trouble (are not failed), and the routine proceeds to step S3. If there is not the proper output-relation at step S2; main ECU 300 determines that some trouble (failure) has occurred in the sensors, and the routine proceeds to step 54.

The proper output-relation of step S2 is determined by judging whether or not both of first and second stroke sensors S/Sen1 and S/Sen2 detect an identical stroke amount (stroke degree) and whether or not first and second master-cylinder pressure sensors MC/Sen1 and MC/Sen2 output respective values of first and second master-cylinder pressures according to this identical stroke amount. In stroke simulator S/Sim, a load according to stroke amount (namely, force reacting to the depression force of pedal) is preset and applied by means of the load setting using an elastic member or the like. Hence, under the operating state of stroke simulator S/Sim, it is possible to judge whether or not the proper relation between the stroke amount and the master-cylinder pressure is satisfied (established). Thus, main ECU 300 detects a trouble in respective sensors.

At step S3, main ECU 300 calculates the manipulated variable of brake. Concretely, main ECU 300 calculates a depression degree of brake pedal manipulated by the driver, from the stroke amount and the master-cylinder pressure from respective sensors.

At step S4, since the proper output-relation is not satisfied, main ECU 300 finds which sensor has failed, namely identifies the failed sensor among respective sensors. For example, main ECU 300 determines that second stroke sensor S/Sen2 is failed; in the case where the proper output-relation between the sensed value of first stroke sensor S/Sen1 and the sensed values of first and second master-cylinder pressure sensors MC/Sen1 and MC/Sen2 is satisfied, and further where the proper output-relation between the sensed value of second stroke sensor S/Sen2 and the sensed values of first and second master-cylinder pressure sensors MC/Sen1 and MC/Sen2 is not satisfied. For example, main ECU 300 determines that second master-cylinder pressure sensor MC/Sen2 is failed; in the case where the proper output-relation between the sensed values of first and second stroke sensors S/Sen1 and S/Sen2 and the sensed value of first master-cylinder pressure sensor MC/Sen1 is satisfied, and further where the proper output-relation between the sensed values of first and second stroke sensors S/Sen1 and S/Sen2 and the sensed value of second master-cylinder pressure sensor MC/Sen2 is not satisfied.

At step S5, main ECU 300 calculates the manipulated variable of brake, on the basis of remaining sensors except the failed sensor(s).

At step S6, main ECU 300 executes the processing for the communication with first and second sub-ECUs 100 and 200. Detailed explanation of this communication processing will be described below.

At step S7, main ECU 300 calculates the fluid-pressure command values (target wheel-cylinder pressures) on the basis of the result of communication processing. These fluid-pressure command values are calculated according to a value of main communication flag Fm set in the communication processing as explained below (the setting of main communication flag Fm will be described in the following explanations about communication processing). When main communication flag Fm is equal to 1, main ECU 300 calculates target wheel-cylinder pressures P*fl to P*rr for respective four road wheels. When main communication flag Fm is equal to 2; main ECU 300 determines that first sub-ECU 100 has been failed, and calculates target wheel-cylinder pressures P*fr and P*rl for only two road wheels which are driven by second sub-ECU 200. When main communication flag Fm is equal to 3; main ECU 300 determines that second sub-ECU 200 has been failed, and calculates target wheel-cylinder pressures P*fl and P*rr for only two road wheels which are driven by first sub-ECU 100.

At step S8, main ECU 300 transmits the fluid-pressure command values calculated at step S7 to first and second sub-ECUs 100 and 200.

(Main ECU Communication Processing)

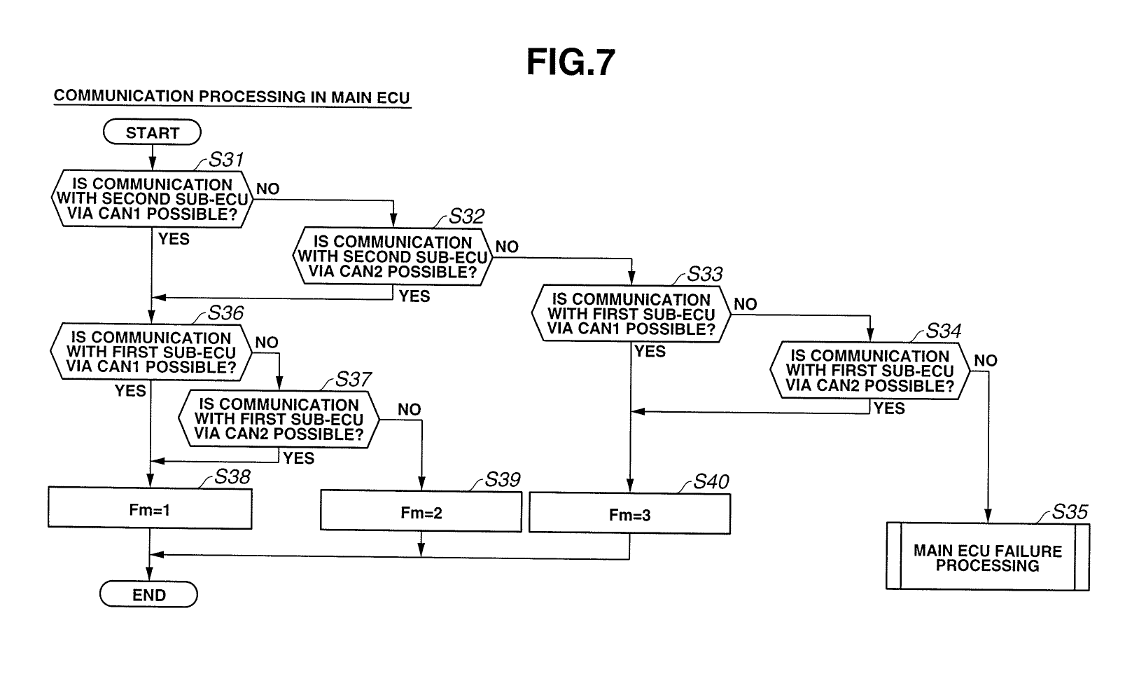

FIG. 7 is a flowchart showing the communication processing which is executed in main ECU 300.

At step S31, main ECU 300 judges whether or not main ECU 300 can communicate with (transmit or receive data to or from) second sub-ECU 200 via CAN communications line CAN1. If YES, namely if main ECU 300 can communicate with second sub-ECU 200 via CAN communications line CAN1, the routine proceeds to step S36. If NO at step S31, the routine proceeds to step S32.

At step S32, main ECU 300 judges whether or not main ECU 300 can communicate with second sub-ECU 200 via CAN communications line CAN2. If YES, namely if main ECU 300 can communicate with second sub-ECU 200 via CAN communications line CAN2, the routine proceeds to step S36. If NO at step S32, the routine proceeds to step S33.

At step S33, main ECU 300 judges whether or not main ECU 300 can communicate with first sub-ECU 100 via CAN communications line CAN1. If YES, namely if main ECU 300 can communicate with first sub-ECU 100 via CAN communications line CAN1, the routine proceeds to step S40. If NO at step S33, the routine proceeds to step S34.

At step S34, main ECU 300 judges whether or not main ECU 300 can communicate with first sub-ECU 100 via CAN communications line CAN2. If YES, namely if main ECU 300 can communicate with first sub-ECU 100 via CAN communications line CAN2, the routine proceeds to step S40. If NO at step S34, the routine proceeds to step S35.

At step S35, main ECU 300 determines that some trouble has occurred in main ECU 300, and executes a processing for failure or a troubleshooting processing for main ECU 300. Accordingly at step S35, main ECU 300 does not generate the communication flag or the like.

At step S36, main ECU 300 judges whether or not main ECU 300 can communicate with first sub-ECU 100 via CAN communications line CAN1. If YES, namely if main ECU 300 can communicate with first sub-ECU 100 via CAN communications line CAN1, the routine proceeds to step S38. If NO at step S36, the routine proceeds to step S37.

At step S37, main ECU 300 judges whether or not main ECU 300 can communicate with first sub-ECU 100 via CAN communications line CAN2. If YES, namely if main ECU 300 can communicate with first sub-ECU 100 via CAN communications line CAN2, the routine proceeds to step S38. If NO at step S37, the routine proceeds to step S39.

At step S38, main ECU 300 determines that all the communication conditions are proper (under normal operating conditions), and sets main communication flag Fm at equal to 1 (Fm=1).

At step S39, main ECU 300 determines that first sub-ECU 100 has failed and second sub-ECU 200 is fine (under normal operating condition). Then, main ECU 300 sets main communication flag Fm at equal to 2 (Fm=2).

At step S40, main ECU 300 determines that second sub-ECU 200 has failed and first sub-ECU 100 is fine. Then, main ECU 300 sets main communication flag Fm at equal to 3 (Fm=3).

(Fluid-pressure Control Processing in Sub-ECU)

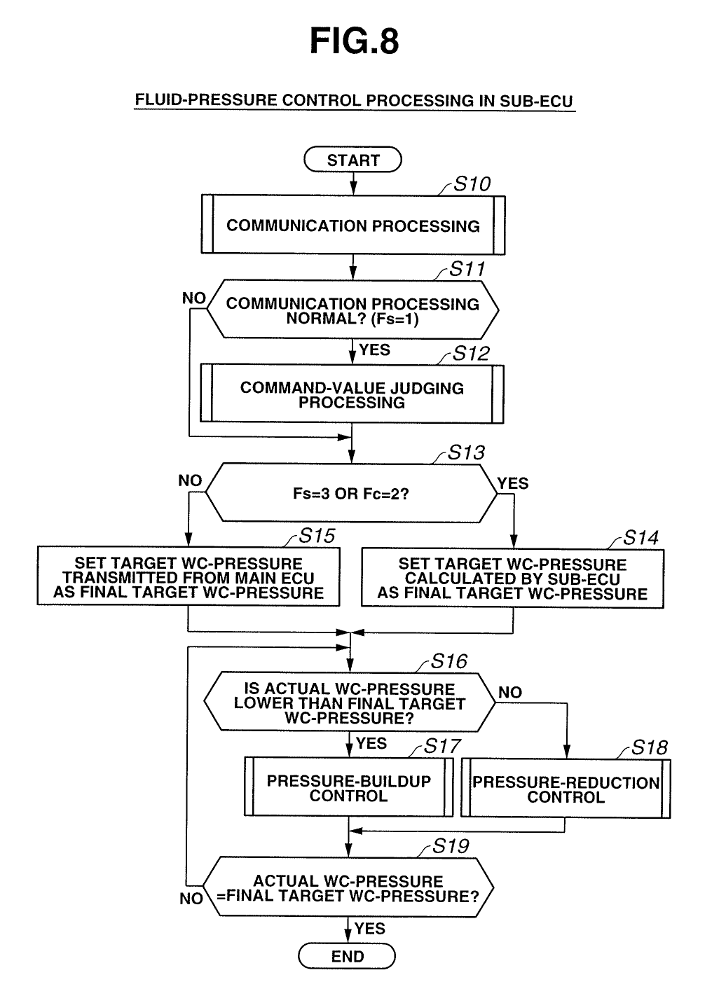

FIG. 8 is a flowchart showing a fluid-pressure control processing which is executed in first and second sub-ECUs 100 and 200. Since both of first and second sub-ECUs 100 and 200 execute the similar fluid-pressure control processing, explanations only about the processing executed in first sub-ECU 100 will be described for the purpose of simplification of the disclosure.

At step S10, first sub-ECU 100 carries out a communication processing regarding first sub-ECU 100. This communication processing is executed so as to judge whether or not the communication between first sub-ECU 100 and main ECU 300 is possible and whether or not the communication between first sub-ECU 100 and second sub-ECU 200 (the other sub-ECU) is possible. At step S10, first sub-ECU 100 determines that the communication processing has ended at “normal” in the case where the communications with all the ECUs (main ECU 300 and second sub-ECU 200) are possible. On the other hand, first sub-ECU 100 determines that the communication processing has ended at “abnormal” in the other cases. This communication processing regarding first sub-ECU 100 will be explained below.

At step S11, first sub-ECU 100 judges whether or not the communication processing has ended at “normal”, namely whether or not a sub-communication flag Fs set by the communication processing is equal to 1 (Fs=1). If YES, namely if the result of communication processing is “normal”; the routine proceeds to step S12. If NO at step S11; the routine proceeds to step S13. The setting of sub-communication flag Fs will be described in the following explanations about sub-ECU communication processing.

At step S12, first sub-ECU 100 executes a command-value judging (checking) processing. This command-value judging processing is executed so as to judge whether or not the backup target wheel-cylinder pressures calculated in first sub-ECU 100 match or have a proper relation with target wheel-cylinder pressures P*fl to P*rr calculated in main ECU 300, in the case where the result of communication processing is “normal” at step S11. Detailed explanations about the command-value judging processing will be described below.

At step S13, first sub-ECU 100 judges whether or not sub-communication flag Fs set in the communication processing is equal to 3, and whether or not a check flag Fc set in the command-value judging (checking) processing is equal to 2. The setting of check flag Fc will be described in the following explanations about the command-value judging processing. If at least either one of the above setting criteria of sub-communication flag Fs and check flag Fc is satisfied, namely if sub-communication flag Fs is equal to 3 or check flag Fc is equal to 2 at step S13; the routine proceeds to step S14. If sub-communication flag Fs is not equal to 3 and check flag Fc is not equal to 2 at step S13; the routine proceeds to step S15. If it has been determined that a self-control line (sub-ECU 100) is failed in the communication processing so that the control of sub-ECU 100 has been suspended; this routine of fluid-pressure control processing in sub-ECU 100 is terminated.

At step S14, first sub-ECU 100 sets the backup target wheel-cylinder pressures calculated by first sub-ECU 100 in accordance with actual master-cylinder pressure (first master-cylinder pressure Pm1), as the final target wheel-cylinder pressures.

At step S15, first sub-ECU 100 sets the target wheel-cylinder pressures P*fl and P*rr transmitted from main ECU 300, as the final target wheel-cylinder pressures.

At step S16, first sub-ECU 100 judges whether or not actual wheel-cylinder pressures Pfl and Prr are low relative to the final target wheel-cylinder pressures. If YES at step S16, the routine proceeds to step S17. If NO at step S16, the routine proceeds to step S18. At step S17, first sub-ECU 100 carries out a pressure-buildup control. At step S18, first sub-ECU 100 carries out a pressure-reduction control.

At step S19, first sub-ECU 100 judges whether or not actual wheel-cylinder pressures Pfl and Prr have become equal to (or have already accorded with) the final target wheel-cylinder pressures. If YES, namely if actual wheel-cylinder pressures Pfl and Prr have become equal to the final target wheel-cylinder pressures; this routine of fluid-pressure control processing in sub-ECU 100 is terminated. If NO, namely if actual wheel-cylinder pressures Pfl and Prr have not yet become equal to (or have not yet accorded with) the final target wheel-cylinder pressures; the steps between step S16 and step S19 are repeatedly executed (as corresponds to so-called servo control).

(Sub-ECU Communication Processing)

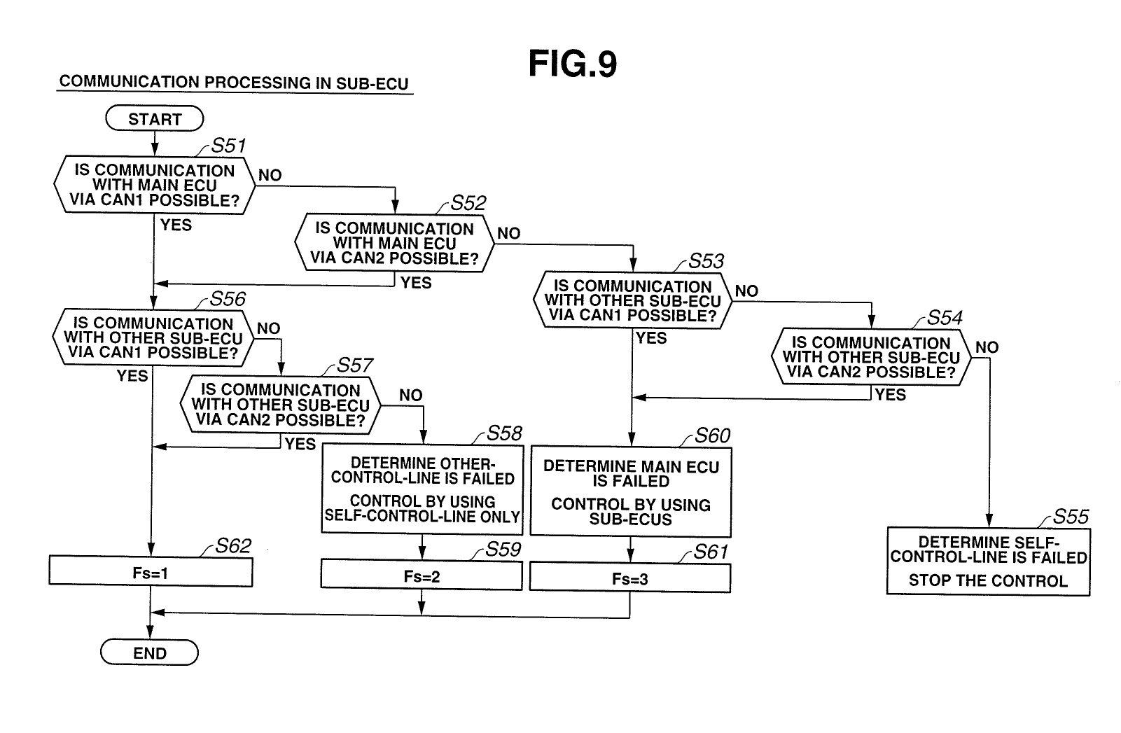

FIG. 9 is a flowchart showing the communication processing which is executed in first and second sub-ECUs 100 and 200. Since both of first and second sub-ECUs 100 and 200 execute the similar communication processing, explanations only about the processing executed in first sub-ECU 100 will be described for the purpose of simplification of the disclosure.

At step S51, first sub-ECU 100 judges whether or not first sub-ECU 100 can communicate with (transmit or receive data to or from) main ECU 300 via CAN communications line CAN1. If YES, namely if first sub-ECU 100 can communicate with main ECU 300 via CAN communications line CAN1, the routine proceeds to step S56. If NO at step S51, the routine proceeds to step S52.

At step S52, first sub-ECU 100 judges whether or not first sub-ECU 100 can communicate with main ECU 300 via CAN communications line CAN2. If YES, namely if first sub-ECU 100 can communicate with main ECU 300 via CAN communications line CAN2, the routine proceeds to step S56. If NO at step S52, the routine proceeds to step S53.

At step S53, first sub-ECU 100 judges whether or not first sub-ECU 100 can communicate with second sub-ECU 200 via CAN communications line CAN1. If YES, namely if first sub-ECU 100 can communicate with second sub-ECU 200 via CAN communications line CAN1, the routine proceeds to step S60. If NO at step S53, the routine proceeds to step S54.

At step S54, first sub-ECU 100 judges whether or not first sub-ECU 100 can communicate with second sub-ECU 200 via CAN communications line CAN2. If YES, namely if first sub-ECU 100 can communicate with second sub-ECU 200 via CAN communications line CAN2, the routine proceeds to step S60. If NO at step S54, the routine proceeds to step S55.

At step S55, first sub-ECU 100 determines that some trouble has occurred in self-control line (first sub-ECU 100). Hence first sub-ECU 100 suspends or stops the control which is conducted by first sub-ECU 100.

At step S56, first sub-ECU 100 judges whether or not first sub-ECU 100 can communicate with sub-ECU 200 via CAN communications line CAN1. If YES, namely if first sub-ECU 100 can communicate with second sub-ECU 200 via CAN communications line CAN1, the routine proceeds to step S62. If NO at step S56, the routine proceeds to step S57.

At step S57, first sub-ECU 100 judges whether or not first sub-ECU 100 can communicate with second sub-ECU 200 via CAN communications line CAN2. If YES, namely if first sub-ECU 100 can communicate with second sub-ECU 200 via CAN communications line CAN2, the routine proceeds to step S62. If NO at step S57, the routine proceeds to step S58.

At step S58, first sub-ECU 100 determines that second sub-ECU 200 is failed (or has some trouble) and the self-control line (first sub-ECU 100) is fine (under normal operating condition). Then, the routine proceeds to step S59, and first sub-ECU 100 sets sub-communication flag Fs at 2 (Fs=2) for the purpose of the control only using first sub-ECU 100 (i.e., control without second sub-ECU 200).

At step S60, first sub-ECU 100 determines that main ECU 300 has some trouble and both of first and second sub-ECUs 100 and 200 are under normal operating condition. Then, the routine proceeds to step S61, and first sub-ECU 100 sets sub-communication flag Fs at 3 (Fs=3) for the purpose of the control only using first and second sub-ECUs 100 and 200.

At step S62, first sub-ECU 100 determines that all the communication conditions are proper (under normal operating conditions), and sets sub-communication flag Fs at 1 (Fs=1).

(Command-value Judging Processing in Sub-ECU)

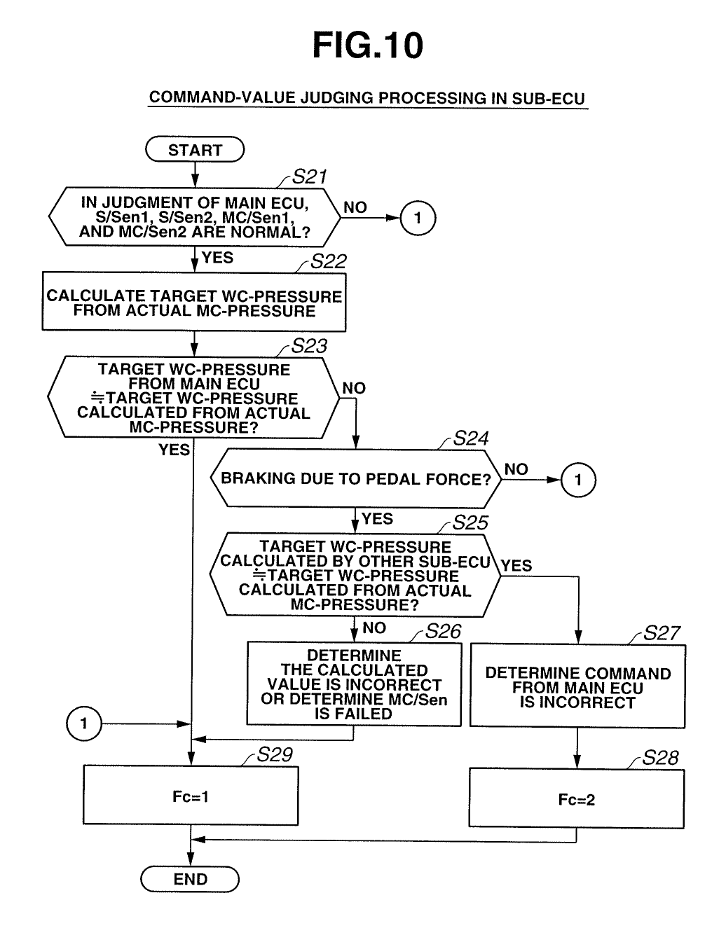

FIG. 10 is a flowchart showing the command-value judging processing (i.e., check processing for command values) which is executed in first and second sub-ECUs 100 and 200. Since both of first and second sub-ECUs 100 and 200 execute the similar check processing, explanations only about first sub-ECU 100 will be described for the purpose of simplification of the disclosure. This command-value judging processing is executed, only in the case where it has been determined that the communication conditions are proper (under normal operating conditions) in the above-mentioned sub-ECU communication processing. Namely, the command-value judging processing is not executed, in the case where it has been determined that any ECU has some trouble (some failure).

At step S21, first sub-ECU 100 judges whether or not some failure has occurred in first and second stroke sensors S/Sen1 and S/Sen2 and first and second master-cylinder pressure sensors MC/Sen1 and MC/Sen2, with reference to the above-mentioned command-value calculating processing in main ECU 300 (see FIG. 6). If some trouble has occurred in first and second stroke sensors S/Sen1 and S/Sen2 and first and second master-cylinder pressure sensors MC/Sen1 and MC/Sen2; the routine proceeds to step S29 since the command-value check based on the signals of respective sensors is impossible. If the respective sensors are under normal operating conditions, the routine proceeds to step S22 in order to carry out the command-value judgment (check) using the signals of respective sensors.

At step S22, first sub-ECU 100 detects the actual master-cylinder pressure (first master-cylinder pressure Pm1) from the sensor which has been determined to have no trouble. Then, (the backup calculation section of) first sub-ECU 100 calculates the backup target wheel-cylinder pressures for four wheels on the basis of this actual master-cylinder pressure.

At step S23, first sub-ECU 100 judges whether or not target wheel-cylinder pressures P*fl, P*fr, P*rl, and P*rr derived from main ECU 300 are substantially equal to the backup target wheel-cylinder pressures calculated from the actual master-cylinder pressure. Concretely, first sub-ECU 100 judges whether or not each value of target wheel-cylinder pressures P*fl to P*rr ranges within a predetermined tolerance of corresponding value of backup target wheel-cylinder pressures calculated from the actual master-cylinder pressure. Namely, first sub-ECU 100 judges whether or not each value of target wheel-cylinder pressures P*fl to P*rr is lower than an upper limit set by adding a predetermined value (the tolerance) to the corresponding value of backup target wheel-cylinder pressures, and also judges whether or not each value of target wheel-cylinder pressures P*fl to P*rr is higher than a lower limit set by subtracting the predetermined value (tolerance) from the corresponding value of backup target wheel-cylinder pressures. If it is determined that target wheel-cylinder pressures P*fl to P*rr are substantially equal to the backup target wheel-cylinder pressures, namely, if each value of target wheel-cylinder pressures P*fl to P*rr is lower than the corresponding upper limit and also higher than the corresponding lower limit; the routine proceeds to step S29. If NO at step S23, the routine proceeds to step S24.

At step S24, first sub-ECU 100 judges whether or not target wheel-cylinder pressures P*fl to P*rr have been generated mainly based on the depression force applied by the driver. Namely, first sub-ECU 100 judges whether or not a current condition of brake control is being carried out due to the depression force applied by the driver. If the current condition of brake control is not based on the depression force, namely for example, if the current condition of brake control is based on vehicle dynamic-behavior control, vehicle-to-vehicle distance control, or the like; the routine proceeds to step S29. If YES at step S24, the routine proceeds to step S25. This is because it is inappropriate that the backup target wheel-cylinder pressures are calculated from the stroke sensor or master-cylinder pressure sensor in the case where the current condition of brake control is based on any braking command other than the pedal depression applied by the driver.

At step S25, first sub-ECU 100 judges whether or not the backup target wheel-cylinder pressures calculated in second sub-ECU 200 are equal to (or accord with) the backup target wheel-cylinder pressures calculated in first sub-ECU 100. If YES at step S25, the routine proceeds to step S27. At step S27, first sub-ECU 100 determines that the command values from main ECU 300 (target wheel-cylinder pressures P*fl to P*rr) are not correct. Then, the routine proceeds to step S28. On the other hand, if NO at step S25, the routine proceeds to step S26. At step S26, first sub-ECU 100 determines that the backup target wheel-cylinder pressures calculated from the actual master-cylinder pressure are not correct, or determines that first and second master-cylinder pressure sensors MC/Sen1 and MC/Sen2 are failed. Then, the routine proceeds to step S29.

At step S28, first sub-ECU 100 sets check flag Fc at 2 (Fc=2). At step S29, first sub-ECU 100 sets check flag Fc at 1 (Fc=1).

Next, operations according to the above-mentioned control processing in the brake control apparatus of first embodiment will now be explained.

[Control Processing in Main ECU]

Main ECU 300 carries out the brake-manipulated-variable calculating processing when the brake-pedal manipulation is detected, and carries out the communication processing based on this brake manipulated variable. Moreover if the other control unit(s) (regenerative brake control unit CU1, radar control unit CU2, and the like) outputs a required braking force; main ECU 300 calculates target wheel-cylinder pressures for respective road wheels on the basis of this required braking force, as the command values.

In the brake-manipulated-variable calculating processing, main ECU 300 calculates or detects the brake manipulated variable (degree of manipulation) based on the brake pedal manipulation by driver, while executing the failure detection for the plurality of sensors at the same time. If main ECU 300 detects some kind of failure in respective sensors, the main ECU 300 outputs the information about this sensor failure to sub-ECUs 100 and 200 via communications.

In the communication processing, main ECU 300 judges whether or not main ECU 300 can communicate with first and second sub-ECUs 100 and 200 through CAN communications line CAN1 or CAN communications line CAN2. Then, main ECU 300 calculates the target wheel-cylinder pressures P*fl to P*rr in accordance with the communication states with first and second sub-ECUs 100 and 200.

\textcircled{1} The case where the communications with all the sub-ECUs are possible. (Fm=1)

In this case, main ECU 300 calculates target wheel-cylinder pressures P*fl to P*rr for four road wheels, and transmits these target wheel-cylinder pressures P*fl to P*rr to each sub-ECU 100, 200 as the command values of main ECU 300 by way of command-value transmitting process.

\textcircled{2} The case where the communication with only either one of first and second sub-ECUs 100 and 200 is impossible. (Fm=2 or Fm=3)

In this case, there is a fear that the control by communication-impossible sub-ECU does not function properly. Hence, main ECU 300 calculates the target wheel-cylinder pressures that are most suitable when only the communication-possible sub-ECU is made to be operated or activated. Then, main ECU 300 transmits these target wheel-cylinder pressures to the communication-possible sub-ECU (i.e., the sub-ECU under normal operating condition) as the command values of main ECU 300 by way of command-value transmitting process.

\textcircled{3} The case where all the communications with respective sub-ECUs are impossible.

In this case, it is determined that main ECU 300 itself is failed (has some trouble) since the possibility that the other two sub-ECUs are failed concurrently is low. Accordingly, main ECU 300 executes the processing for the failure of main ECU 300. Concretely, main ECU 300 switches the ongoing brake control to a control using only first and second sub-ECUs 100 and 200 (without using the command-values of main ECU 300).

[Control Processing in Sub-ECU]

Next, operations in sub-ECUs will now be explained. Sub-ECU 100 or 200 carries out the communication processing in which it is judged whether or not the communications with main ECU 300 and another sub-ECU are under normal operating condition. When it is determined that the communications are under normal operating condition in the communication processing, sub-ECU 100 or 200 executes the command-value judging (checking) processing. Further, sub-ECU 100 or 200 executes the servo control processing in which wheel-cylinder pressures Pfl to Prr are adjusted so as to be increased and reduced in accordance with the set (final) target wheel-cylinder pressures.

\textcircled{1} The case where both of the communication between first sub-ECU 100 and second sub-ECU 200 and the communication between first and second sub-ECUs 100 and 200 and main ECU 300 are possible. (Fs=1)

In this case, sub-ECU 100 or 200 determines that the communications are in normal operating condition (not failed), and sets the command values received from main ECU 300 as the target wheel-cylinder pressures. Then in this case, sub-ECU 100 or 200 executes the command-value judging processing in order to check a properness of these command values.

\textcircled{2} The case where only the communication between first sub-ECU 100 and second sub-ECU 200 is impossible. (Fs=2)

In this case, it is determined that the sub-ECU capable of communicating with main ECU 300 is normal (not failed) and the other sub-ECU incapable of communicating with main ECU 300 is abnormal (failed). At this time, as mentioned above, main ECU 300 has calculated the target wheel-cylinder pressures suitable when using only one not-failed sub-ECU, since either of first and second sub-ECUs 100 and 200 is abnormal (Fm=2 or Fm=3). Accordingly, sub-ECU 100 or 200 sets the command values received from main ECU 300 as the target wheel-cylinder pressures.

\textcircled{3} The case where both of first sub-ECU 100 and second sub-ECU 200 cannot communicate with main ECU 300. (Fs=3)

In this case, sub-ECU 100 or 200 determines that main ECU 300 is abnormal. At this time, main ECU 300 has recognized that main ECU 300 itself is abnormal (has some failure) and has executed the processing for failure. Accordingly, sub-ECU 100 or 200 sets the backup target wheel-cylinder pressures calculated from the actual master-cylinder pressure by first and second sub-ECUs 100 and 200, as the final target wheel-cylinder pressures. By virtue of this configuration, even if some trouble occurs in main ECU 300, a normally-minimum-necessary braking force control based on the brake-pedal manipulation of driver can be maintained.

According to the brake control apparatus in the first embodiment, the following effects listed with configurations of the first embodiment can be obtained.

\textcircled{1} In the first embodiment, main ECU 300 calculates the target wheel-cylinder pressure(s) which is a target braking controlled variable, in accordance with the amount of brake manipulation of driver (stroke amount, master-cylinder pressure). Each of first and second sub-ECUs 100 and 200 includes the backup calculation section configured to calculate the backup target wheel-cylinder pressure(s) which is a backup target braking controlled variable (step S22), by receiving the amount of brake manipulation separately from main ECU 300. Further, each of first and second sub-ECUs 100 and 200 is configured to properly select one from the target wheel-cylinder pressure and the backup target wheel-cylinder pressure in accordance with operating conditions of main ECU 300 and/or first and second sub-ECUs 100 and 200. Further, each of first and second sub-ECUs 100 and 200 is configured to output drive signals to the actuator(s) (or loads, e.g., motor M1 and respective electromagnetic valves of shutoff valve S.OFF/V, valves IN/V(FL) and IN/V(RR) for front-left and rear-right wheels, and valves OUT/V(FL) and OUT/V(RR) for front-left and rear-right wheels) provided for generating or giving braking force of each road wheel, so as to bring the wheel-cylinder pressure of each road wheel closer to the selected one of the target wheel-cylinder pressure and the backup target wheel-cylinder pressure.

Namely, while the normal calculation based on the state (such as pedal stroke) of driver's brake manipulation is conducted by main ECU 300 (broader control unit), each of first and second sub-ECUs 100 and 200 conducts the backup calculation. Therefore, even if one of main ECU 300 and sub-ECU 100, 200 becomes failed, another of main ECU 300 and sub-ECU 100, 200 continues to calculate the target wheel-cylinder pressure. Hence, the automatic brake control can be continued to improve the safety-performance.

\textcircled{2} In the first embodiment, when main ECU 300 becomes failed, first and second sub-ECUs 100 and 200 are configured to output drive signals to motors M1 and M2 and the like, to bring the wheel-cylinder pressure of each road wheel closer to the backup target wheel-cylinder pressure calculated by the backup calculation section. Therefore, the target braking controlled variable can be attained by means of only first and second sub-ECUs 100 and 200, and hence the brake-by-wire control can be continued while ensuring the minimum-necessary braking force.

\textcircled{3} In the first embodiment, main ECU 300 and/or sub-ECU 100, 200 includes the main microcomputer and the sub-microcomputer to construct a dual system. Therefore, these two microcomputers have a function of monitoring each other, so that the fail-safe performance of arithmetic device (microprocessor) is enhanced.

\textcircled{4} In the first embodiment, main ECU 300 and/or sub-ECU 100, 200 is configured to determine that one of main ECU 300 and sub-ECU 100, 200 is failed when the difference between the target wheel-cylinder pressure calculated by main ECU 300 and the backup target wheel-cylinder pressure calculated by sub-ECU 100, 200 is greater than a predetermined value. Therefore, the mutual monitoring between these main ECU and sub-ECU can be realized so that the fail-safe performance is further enhanced.

\textcircled{5} In the first embodiment, each of first and second sub-ECUs 100 and 200 is formed integral with the drive circuits for driving respective electromagnetic valves and/or motor M1, M2. Namely, the circuit board integrally including the sub-ECU and the drive circuits can be used. Therefore, it is unnecessary to use harnesses for connecting the sub-ECU with the drive circuits (in hydraulic unit HU). Thereby, a downsizing in control system is realized to improve a flexibility in layout.

\textcircled{6} In the first embodiment, gear-type pump P1, P2 is used as a fluid-pressure source provided independently of master cylinder M/C, and is adapted to supply fluid pressure directly to each wheel cylinder WC. By using gear-type pump P1, P2 driven by motor M1, M2 as a fluid-pressure source; fluid pressure can be introduced to each wheel cylinder WC without any intervening accumulator. Thereby, it is necessary to secure a space for mounting the accumulator inside the housing of hydraulic unit HU. Hence, the downsizing in control system can be further enhanced.

\textcircled{7} In the first embodiment, the amount of brake manipulation of a driver is determined from at least one of the sensed value of fluid pressure inside master cylinder M/C and the sensed value of pedal stroke. Main ECU 300 is configured to calculate the target wheel-cylinder pressure(s) on the basis of two of the sensed value of fluid pressure inside master cylinder M/C and the sensed value of the pedal stroke, and each sub-ECU is configured to calculate the backup target wheel-cylinder pressure(s) on the basis of only one of the sensed value of fluid pressure inside master cylinder M/C and the sensed value of pedal stroke. Thereby, the broader control unit calculates the normal target braking controlled variable(s) on the basis of the amount of brake manipulation obtained from two of the sensed value of fluid pressure inside master cylinder M/C and the sensed value of pedal stroke, while each of the subordinate control units calculates the backup target braking controlled variable(s) on the basis of the amount of brake manipulation obtained from only one of the sensed value of fluid pressure inside master cylinder M/C and the sensed value of pedal stroke. Therefore, the computing load in each subordinate control unit can be lightened to secure a reliable backup.

### Second Embodiment

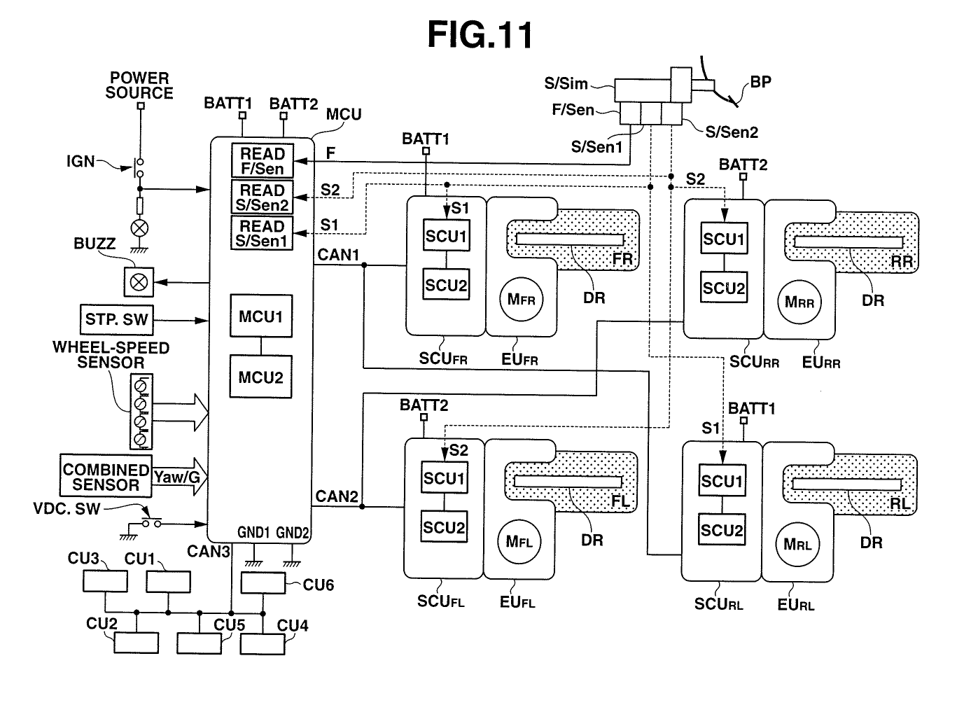

Next, a second embodiment according to the present invention will now be explained. FIG. 11 is a schematic system configuration view showing a brake-by-wire control system in a brake control apparatus according to the second embodiment. Components having the same reference marks as the first embodiment have same features as the first embodiment, and detailed explanations thereof will be omitted for the purpose of simplification of the disclosure.

[System Configuration]

The brake control apparatus according to the second embodiment is exemplified as a four-wheel brake-by-wire system, and includes four electrical calipers (electrical units) EUFR, EUFL, EURR, and EURL each capable of controlling or adjusting a position of brake pad or a pressing force of brake pad independently of the manipulation of brake pedal BP by a driver.

As a control unit, the brake control apparatus includes a main control unit MCU (hereinafter also called “first control unit”) and sub-control units SCUFR, SCUFL, SCURR, and SCURL (hereinafter also called “second control unit”). Main control unit MCU serves to calculate respective target braking forces F*fl, F*fr, F*rl, and F*rr for road wheels FL, FR, RL, and RR. Sub-control units SCUFR, SCUFL, SCURR, and SCURL serve to drive four electrical calipers EUFR, EUFL, EURR, and EURL.

Sub-control units SCUFR, SCUFL, SCURR, and SCURL drive respective electrical calipers EUFR, EUFL, EURR, and EURL on the basis of commands derived from main control unit MCU. A stroke simulator S/Sim applies reaction force to brake pedal BP.

Each of four electrical units EUFR, EUFL, EURR, and EURL includes a corresponding motor MFR, MFL, MRR, MRL. Each of four electrical units EUFR, EUFL, EURR, and EURL is an electrical actuator capable of generating braking force for corresponding road-wheel independently of the other road-wheels, by pressing the brake pad against a rotor DR of road wheel by means of rotation (drive) of the corresponding motor. A first electric power source BATT1 is connected with sub-control units SCUFR and SCURL to supply electric power to sub-control units SCUFR and SCURL. A second electric power source BATT2 is connected with sub-control units SCURR and SCUFL to supply electric power to sub-control units SCURR and SCUFL. That is, power sources BATT1 and BATT2 are provided to construct a so-called diagonal split layout of power supply system, sometimes termed “X-split layout”.

Respective sub-control units SCUFR, SCUFL, SCURR, and SCURL are provided mechanically and electrically integral with electrical calipers EUFR, EUFL, EURR, and EURL. Also, an electrical circuit board of each of sub-control units SCUFR, SCUFL, SCURR, and SCURL is provided integral with an electrical circuit board for a drive circuit for driving the motor M (MFR, MFL, MRR, or MRL). Since the electrical circuit board integrally including the circuits of sub-control unit SCU (ECU) and the drive circuit for motor M is used, it is unnecessary to use harnesses for connecting sub-control unit SCU with electrical unit EU. Accordingly, a downsizing in control system can be improved.

[Main Control Unit]

Main control unit MCU is a broader central processing unit (CPU) that calculates target front-left braking force F*fl, target rear-right braking force F*rr, target front-right braking force F*fr, and target rear-left braking force F*rl for electrical calipers EUFR, EUFL, EURR, and EURL. Main control unit MCU is connected to both of first electric power source BATT1 and second electric power source BATT2. Main control unit MCU can operate or work when at least one of power sources BATT1 and BATT2 is operating normally. Main control unit MCU is started responsively to ignition switch signal IGN derived from an ignition switch, or responsively to a MCU-starting requirement from each of the other control units CU1 to CU6 connected via communications line CAN3 with main control unit MCU.

Main control unit MCU receives a stroke signal S1 derived from a first stroke sensor S/Sen1, a stroke signal S2 derived from a second stroke sensor S/Sen2, and a pressing force (tread force) signal F of brake-pedal derived from a thrust sensor F/Sen.

Main control unit MCU also receives a signal indicative of vehicle speed (wheel speed) VSP, a signal indicative of yaw rate Y, and a signal indicative of longitudinal acceleration G. Main control unit MCU also receives a signal from a stop lamp switch STP.SW, so as to detect the manipulation (depression) of brake pedal BP by the driver without using stroke sensor signals S1 and S2 and brake-pedal pressing force signal F.

Two central processing units (CPUs), namely a first CPU MCU1 and a second CPU MCU2, are provided in main control unit MCU for arithmetic calculations. First CPU MCU1 is defined as a main main microcomputer (microprocessor), and second CPU MCU2 is defined as a sub-microcomputer (sub-microprocessor) to construct a dual system. Thereby, these first and second CPUs MCU1 and MCU2 have a function of monitoring each other, so that fail-safe performance and safety performance of arithmetic device are enhanced.

Respective first and second CPUs MCU1 and MCU2 are connected to sub-control units SCUFR, SCUFL, SCURR, and SCURL via CAN communications lines CAN1 and CAN2. Signals indicating motor driving forces and actual braking forces Ffl, Ffr, Frl, and Frr are inputted via sub-control units SCUFR, SCUFL, SCURR, and SCURL into first and second CPUs MCU1 and MCU2. This CAN communications line CAN1 is provided to allow sub-control units SCUFR and SCURL to communicate with main control unit MCU. On the other hand, CAN communications line CAN2 is provided to allow sub-control units SCUFL and SCURR to communicate with main control unit MCU.

As mentioned above, these CAN communications lines CAN1 and CAN2 are arranged respectively to cause two sub-control units (SCUFR and SCURL, or SCUFL and SCURR) for diagonally-positioned two road-wheels to communicate with (transmit information to or from) main control unit MCU. Namely, the brake control apparatus according to this embodiment is configured or designed to construct a dual CAN-communications-line system so that CAN communications lines CAN1 and CAN2 electrically construct the so-called diagonal split layout of CAN-communications-line system, sometimes termed “X-split layout”. By virtue of such layout, even when carrying out a fail-safe control by brake-by-wire control using only two road-wheels, a braking control securing the stable vehicle behavior can be performed.

On the basis of the input information such as stroke signals S1 and S2, tread force signal F, and signals of actual braking forces Ffl, Ffr, Frl, and Frr; first and second CPUs MCU1 and MCU2 calculate target braking forces F*fl, F*fr, F*rl, and F*rr, and output the calculated target braking forces F*fl to F*rr via CAN communications lines CAN1 and CAN2 to respective sub-control units SCUFR, SCUFL, SCURR, and SCURL. Regarding this calculation, first CPU MCU1 may calculate target front-right and rear-left braking forces F*fr and F*rl while second CPU MCU2 calculates target front-left and rear-right braking forces F*fl and F*rr. In lieu thereof, first CPU MCU1 may calculate all the four target braking forces F*fl, F*fr, F*rl, and F*rr, while second CPU MCU2 is used as a backup CPU for first CPU MCU1.

Main control unit MCU functions to start up each of sub-control units SCUFR, SCUFL, SCURR, and SCURL via CAN communications lines CAN1 and CAN2. In this embodiment, main control unit MCU generates four of a command signal for starting up sub-control unit SCUFR, a command signal for starting up sub-control unit SCUFL, a command signal for starting up sub-control unit SCURR, and a command signal for starting up sub-control unit SCURL independently of each other. In lieu thereof, sub-control units SCUFR, SCUFL, SCURR, and SCURL may be started up simultaneously in response to a single command signal from main control unit MCU. Alternatively, sub-control units SCUFR, SCUFL, SCURR, and SCURL may be started up simultaneously in response to ignition switch signal IGN.

During execution of vehicle dynamic-behavior control including anti-skid brake control (often abbreviated to “ABS”, which is executed for increasing or decreasing a braking force for wheel-lock prevention), vehicle dynamics control (often abbreviated to “VDC”, which is executed for increasing or decreasing a braking force to prevent side slip occurring due to instable vehicle behaviors), traction control (often abbreviated to “TCS”, which is executed for acceleration-slip suppression of drive wheels), and the like; input information such as vehicle speed (vehicle wheel speed) VSP, yaw rate Y, and longitudinal acceleration G is further extracted for executing the braking control concerning target braking forces F*fl, F*fr, F*rl, and F*rr. During the vehicle dynamics control (VDC), a warning buzzer BUZZ emits a buzzing sound cyclically to warn the driver or vehicle occupants that the VDC system comes into operation. A VDC switch VDC.SW serving as a man-machine interface is also provided so as to manually engage or disengage the VDC function in accordance with the driver's wishes.

[Sub-Control Unit]

Sub-control units SCUFR, SCUFL, SCURR, and SCURL receive stroke sensor signals S1 and S2 and signals indicating target braking forces F*fl, F*fr, F*rl, and F*rr outputted or generated from main control unit MCU, and also receive signals indicating the driving amounts (i.e., driving degree or manipulated variable) of motors MFR, MFL, MRR, and MRL and actual braking forces Ffl, Ffr, Frl, and Frr. Here, stroke sensor signal S1 of first stroke sensor S/Sen1 is inputted to sub-control units SCUFR and SCURL, and stroke sensor signal S2 of second stroke sensor S/Sen2 is inputted to sub-control units SCUFL and SCURR.

As mentioned above, these first and second stroke sensors S/Sen1 and S/Sen2 are provided to enable to calculate the target braking forces (target controlled variables for brake control) for diagonally-positioned two road-wheels. Namely, the brake control apparatus according to this embodiment is configured to construct a dual sensor-signal system so that first and second stroke sensors S/Sen1 and S/Sen2 electrically construct a so-called diagonal split layout of sensor-signal system, sometimes termed “X-split layout”. By virtue of such layout, even when carrying out a fail-safe control by brake-by-wire control using only two road-wheels, the braking control securing stable vehicle behavior can be performed.

Each of sub-control units SCUFR, SCUFL, SCURR, and SCURL includes a backup calculation section serving to briefly calculate backup target braking forces on the basis of the stroke amount (stroke degree), separately from target braking forces F*fl, F*fr, F*rl, and F*rr calculated by main control unit MCU.

On the basis of the latest up-to-date informational data (more recent data) about driving amounts of motors and actual braking forces Ffl, Ffr, Frl, and Frr, the braking force control is performed to realize target braking forces F*fl, F*fr, F*rl, and F*rr (or backup target braking forces) by driving motors MFR, MFL, MRR, and MRL incorporated in respective electrical units EUFR, EUFL, EURR, and EURL provided with sub-control units SCUFR, SCUFL, SCURR, and SCURL.

Each of sub-control units SCUFR, SCUFL, SCURR, and SCURL constructs a servo control system that continuously executes the braking-force control for corresponding wheel FL, FR, RL, or RR on the basis of the inputted value concerning target braking force F*fl, F*fr, F*rl, or F*rr, in such a manner as to bring the corresponding actual braking force Ffl, Ffr, Frl, or Frr closer to this inputted value (i.e., as to cause actual braking force Ffl, Ffr, Frl, or Frr to converge to this inputted value) until a new target value is inputted.

[Target Value Calculation and Drive Control, Separated from Each Other]

As discussed above, main control unit MCU according to the second embodiment is configured to execute arithmetic processing for target values F*fl, F*fr, F*rl, and F*rr for sub-control units SCUFR, SCUFL, SCURR, and SCURL, but not configured to execute the drive control for motors. Assuming that main control unit MCU is configured to execute the drive control as well as the target braking-force calculations, main control unit MCU must output driving commands to sub-control units SCUFR, SCUFL, SCURR, and SCURL in accordance with cooperative control with the other control units CU1 to CU6 by way of CAN communications and the like.

In such a case, target braking forces F*fl, F*fr, F*rl, and F*rr are outputted after the arithmetic operations of CAN communications line CAN3 and the other control units CU1 to CU6 have terminated. On the assumption that a transmission speed of CAN communications line CAN3 and operation speeds of the other control units CU1 to CU6 are slow, there is an undesirable response delay in brake control.

One way to avoid such undesirable response delay is to increase the transmission speed of each of communications lines needed for connections with the other controllers installed inside the vehicle. However, this leads to another problem of increased costs. Additionally, a deterioration in fail-safe performance occurs owing to noise caused by the increased transmission speed.

For the reasons discussed above, in this embodiment, the role of main control unit MCU in brake control is limited to the arithmetic operations of target braking forces F*fl, F*fr, F*rl, and F*rr for sub-control units SCUFR, SCUFL, SCURR, and SCURL. Namely, the driving control for electrical calipers EUFR, EUFL, EURR, and EURL is performed by sub-control units SCUFR, SCUFL, SCURR, and SCURL each including servo control system.

With the above-mentioned configuration, sub-control units SCUFR, SCUFL, SCURR, and SCURL specialize in the driving control for electrical calipers EUFR, EUFL, EURR, and EURL, while the cooperative control with the other control units CU1 to CU6 is performed by main control unit MCU. Thus, it becomes possible to execute the brake control without being affected by several factors, i.e., the transmission speed of CAN communications line and the operation speeds of control units CU1 to CU6. The above-mentioned backup calculation which is executed in each of sub-control units SCUFR, SCUFL, SCURR, and SCURL does not include complex arithmetic, namely is executed relatively simply on the basis of stroke amount. Hence, this backup calculation does not increase a load in arithmetic processing that much.

Therefore, even when integrated controllers (units) for a regenerative cooperative brake system necessary for a hybrid vehicle (HV) or a fuel-cell vehicle (FCV), an integrated vehicle control system, and/or an intelligent transport system (ITS) are further added; it is possible to ensure or realize a high brake control responsiveness while smoothly planning a fusion with these additional units/systems, by independently controlling the brake control system separately from the other control systems.

The brake control apparatus equipped with BBW system as this embodiment, requires a precise brake control suited to the manipulated variable (depression stroke) of brake pedal BP, during normal braking operations which occur frequently. Thus, separating arithmetic operations of target braking forces F*fl, F*fr, F*rl, and F*rr for electrical calipers EUFR, EUFL, EURR, and EURL from the driving control for electrical calipers EUFR, EUFL, EURR, and EURL is more effective and advantageous.

However, from a view point of fail-safe performance, it is not favorable that the target braking forces cannot be calculated in the case where main control unit MCU becomes in failed condition. Therefore, the brake control apparatus in this embodiment is designed to ensure a normally-minimum-necessary (backup) braking force by means of sub-control units SCUFR, SCUFL, SCURR, and SCURL even when main control unit MCU is in some failed condition, although the complex cooperative control or vehicle dynamic-behavior control is consistently performed by main control unit MCU. Concretely, sub-control units SCUFR, SCUFL, SCURR, and SCURL perform the backup calculation for target braking forces. Thus, the braking-force control according to the stroke amount can be continued by sub-control units SCUFR, SCUFL, SCURR, and SCURL if main control unit MCU becomes failed.

The brake control apparatus in this second embodiment is not equipped with a mechanical backup system (manual brake circuit) that works in the case where some trouble occurs in the brake-by-wire (BBW) control system. Accordingly, if the brake-by-wire control system itself is shut off in such case where some trouble has occurred in the brake-by-wire control system, the braking force of vehicle cannot be secured. Therefore, at this time, by means of the above-mentioned backup calculation of sub-control units SCUFR, SCUFL, SCURR, and SCURL, the simplified (backup) brake-by-wire control becomes executable. Thereby, it is possible to secure the braking force without shutting off the brake-by-wire control system itself.

[Stroke Simulator]

Stroke simulator S/Sim is provided to generate a reaction force of brake pedal BP. Stroke simulator S/Sim is connected with first and second stroke sensors S/Sen1 and S/Sen2 and thrust sensor F/Sen. Thrust sensor F/Sen functions to estimate pressing force (thrust) F which is a brake-pedal tread force by the driver. Stroke sensor signals S1 and S2 of brake pedal BP and pressing force F are inputted to main control unit MCU. Although signals of first and second stroke sensors S/Sen1 and S/Sen2 are inputted to each of sub-control units SCUFR, SCUFL, SCURR, and SCURL in the second embodiment, also the signal of thrust sensor F/Sen may be inputted to each of sub-control units SCUFR, SCUFL, SCURR, and SCURL as well as the signals of first and second stroke sensors S/Sen1 and S/Sen2.

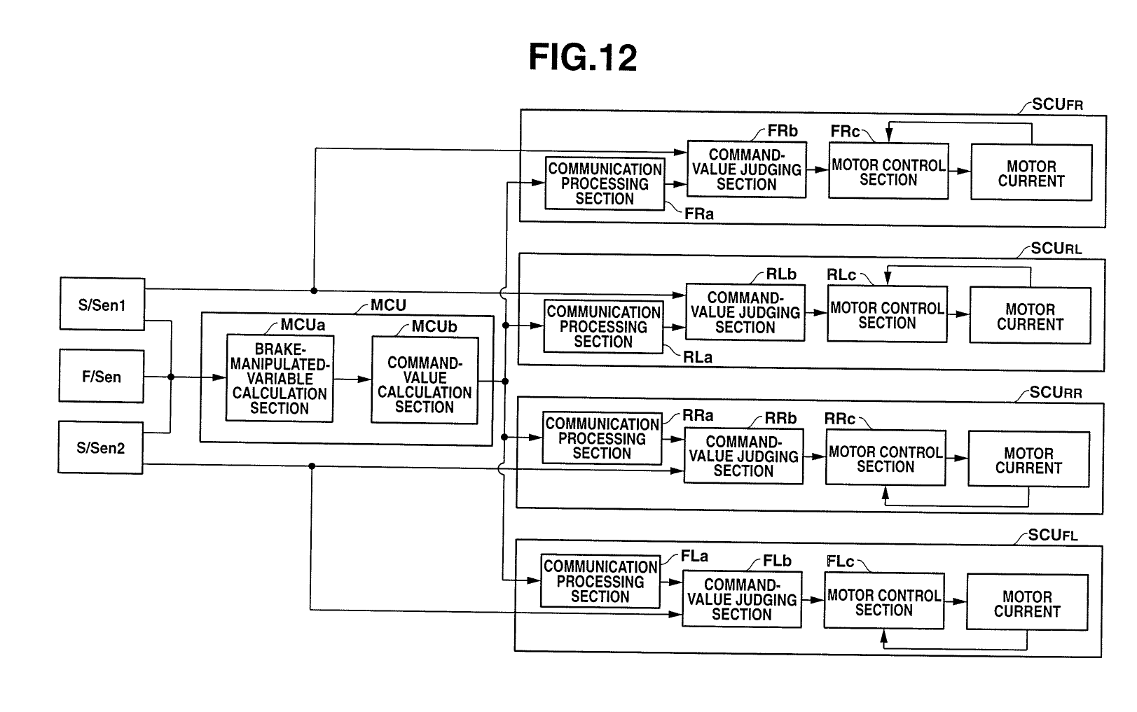

FIG. 12 is a schematic block diagram showing the control configuration of brake-by-wire (BBW) system in the second embodiment. As shown in FIG. 12, main control unit MCU includes a brake-manipulated-variable calculation section MCUa and a command-value calculation section MCUb. Brake-manipulated-variable calculation section MCUa calculates the brake manipulated variable of driver (manipulation quantity, i.e., the depression stroke amount of brake pedal or an amount corresponding to the state of brake manipulation such as brake-pedal tread force) from each sensor signal. Command-value calculation section MCUb calculates target braking forces F*fl, F*fr, F*rl, and F*rr for respective wheels as the command values on the basis of the calculated brake manipulated variable. Target braking forces F*fl, F*fr, F*rl, and F*rr calculated by command-value calculation section MCUb are transmitted to sub-control units SCUFR, SCUFL, SCURR, and SCURL.

Each of sub-control units SCUFR, SCUFL, SCURR, and SCURL includes a communication processing section FRa, RLa, RRa, FLa serving to carry out a communication processing for the communication with main control unit MCU.

Each of sub-control units SCUFR and SCURL further includes a command-value judging section FRb, RLb. Command-value judging section FRb, RLb calculates the backup target braking forces in accordance with first stroke sensor S/Sen1, and determines final target braking forces by judging or checking the calculated backup target braking forces in comparison with target braking forces F*fl, F*fr, F*rl, and F*rr transmitted from main control unit MCU.

Each of sub-control units SCUFL and SCURR further includes a command-value judging section FLb, RRb. Command-value judging section FLb, RRb calculates the backup target braking forces in accordance with second stroke sensor S/Sen2, and determines final target braking forces by judging or checking the calculated backup target braking forces in comparison with target braking forces F*fl, F*fr, F*rl, and F*rr transmitted from main control unit MCU.

Each of sub-control units SCUFR, SCUFL, SCURR, and SCURL further includes a motor control section FRc, RLc, RRc, FLc that controls motor MFR, MRL, MRR, MFL to achieve the final target braking force, on the basis of a value of electric-current passing in motor MFR, MRL, MRR, MFL.

[Brake-By-Wire Control Processing]

The brake-by-wire control processing in the second embodiment will now be explained.

(Command-value Calculating Processing in Main Control Unit)

A basic command-value calculating processing in main control unit MCU in the second embodiment is similar as the command-value calculating processing shown in FIG. 6 of the first embodiment. Concretely, the command-value calculating processing in main control unit MCU is understandable from FIG. 6, by changing the wordings of “fluid-pressure command value” and “two master-cylinder pressure sensors” respectively to “braking-force command value” and “one thrust sensor”. Hence, the detailed explanations thereof will be omitted for the purpose of simplification of the disclosure.

(Communication Processing in Main Control Unit)

A basic communication processing in main control unit MCU in the second embodiment is similar as the communication processing shown in FIG. 7 of the first embodiment. Concretely, the communication processing in main control unit MCU is understandable from FIG. 7, by changing the wordings of “second sub-ECU 200” and “first sub-ECU 100” respectively to “sub-control unit SCUFR” and “sub-control unit SCUFL” and further by adding the same steps as the steps related to “second sub-ECU 200” and “first sub-ECU 100” respectively for the executions related to “sub-control unit SCURL” and “sub-control unit SCURR”. Hence, the detailed explanations thereof will be omitted.

(Fluid-pressure Control Processing in Sub-Control Unit)

A basic fluid-pressure control processing in sub-control unit SCU in the second embodiment is similar as the fluid-pressure control processing shown in FIG. 8 of the first embodiment. Concretely, the fluid-pressure control processing in sub-control unit SCU is understandable from FIG. 8, by changing the wordings of “target wheel-cylinder pressures from main ECU 300” and “target wheel-cylinder pressures calculated from the actual master-cylinder pressure” respectively to “target braking forces from main control unit MCU” and “target braking forces calculated from the stroke amount” and further by changing the wordings of “pressure-buildup control” and “pressure-reduction control” respectively to “increasing control of electric current value” and “reducing control of electric current value”. Hence, the detailed explanations thereof will be omitted.

(Communication Processing in Sub-Control Unit)

A basic communication processing in sub-control unit SCU in the second embodiment is similar as the communication processing shown in FIG. 9 of the first embodiment. Concretely, the communication processing in sub-control unit SCU is understandable from FIG. 9, by changing the wordings of “main ECU 300” and “other sub-ECU” respectively to “main control unit MCU” and “other sub-control unit SCU”. Hence, the detailed explanations thereof will be omitted.

(Command-value Judging Processing in Sub-Control Unit)

A basic command-value judging processing in sub-control unit SCU in the second embodiment is similar as the command-value judging processing shown in FIG. 10 of the first embodiment. Concretely, the command-value judging processing in sub-control unit SCU is understandable from FIG. 10, by changing the wordings of “values of two master-cylinder pressure sensors”, “target wheel-cylinder pressures calculated from the actual master-cylinder pressure” and “master-cylinder pressure sensor MC/Sen is failed” respectively to “value of one thrust sensor”, “target braking forces calculated from the stroke amount”, and “stroke sensor S/Sen is failed”. Hence, the detailed explanations thereof will be omitted.

The structure according to this second embodiment does not include a mechanical backup system (manual brake circuit) unlike the first embodiment. Accordingly, when main control unit MCU fails, there is a case where target braking forces F*fl to F*rr for generating braking forces at respective electrical calipers EUFL to EURR cannot be calculated. Therefore in the structure according to this second embodiment, at this time, sub-control units SCUFR, SCUFL, SCURR, and SCURL can calculate the backup target braking forces by receiving stroke sensor signals S1 and S2. Thereby, even if main control unit MCU fails, each of electrical calipers EUFR, EUFL, EURR, and EURL can generate braking force on its own.

Each of sub-control units SCUFR, SCUFL, SCURR, and SCURL calculates the backup target braking forces so as to enable only a minimum-necessary braking control based on the driver's manipulation of brake pedal. In other words, calculations for the brake control associated with complex arithmetic such as vehicle-to-vehicle distance control or vehicle dynamic-behavior control are not performed by sub-control units SCUFR, SCUFL, SCURR, and SCURL. Thus, sub-control units SCUFR, SCUFL, SCURR, and SCURL take charge of only the minimum-necessary braking control extracted from whole brake control. Accordingly, each of sub-control units SCUFR, SCUFL, SCURR, and SCURL has only to add a slight arithmetic, as compared with its arithmetic load necessary at the time of normal operating condition of main control unit MCU.

Therefore, the increase in arithmetic load can be avoided so that it becomes unnecessary that the sub-control unit is equipped with a microcomputer or the like with excessive specifications (high-speed performance). This also leads to a reduction of cost. In addition, although each of sub-control units SCUFR, SCUFL, SCURR, and SCURL calculates by reading stroke sensor signals S1 and S2 in the second embodiment, each of sub-control units SCUFR, SCUFL, SCURR, and SCURL may calculate by reading only pressing force (thrust) signal F of thrust sensor F/Sen or by reading both of pressing force signal F and stroke sensor signals S1 and S2.

According to the brake control apparatus in the second embodiment, the following effects listed with configurations of the second embodiment can be obtained.

\textcircled{1} In the second embodiment, main control unit MCU calculates the target braking force which is a target braking controlled variable, in accordance with the amount of brake manipulation of driver. Each of sub-control units SCUs calculates the backup braking force which is a backup target braking controlled variable separately from main control unit MCU, by receiving the amount of brake manipulation. Further, each of sub-control units SCUs is configured to properly select one of the target braking force and the backup target braking force in accordance with operating conditions of main control unit MCU and sub-control units SCUs. Further, each of sub-control units SCUs is configured to output drive signal to motor M so as to bring the braking force of electrical caliper EU of each road wheel closer to the selected one of the target braking force and the backup target braking force.

Namely, while the normal calculation based on the state of driver's brake manipulation is conducted by main control unit MCU, each of sub-control units SCUFR, SCUFL, SCURR, and SCURL conducts the backup calculation. Therefore, even if one of main control unit MCU and sub-control unit SCUFR, SCUFL, SCURR, SCURL becomes failed, another of main control unit MCU and sub-control unit SCUFR, SCUFL, SCURR, SCURL continues to calculate the target braking force. Hence, the automatic brake control can be continued to improve the safety-performance.

\textcircled{2} In the second embodiment, when main control unit MCU becomes in some failed condition, sub-control units SCUFR, SCUFL, SCURR, and SCURL are configured to output drive signals to motors MFR, MFL, MRR, and MR, to bring the braking force of electrical caliper EU of each road wheel closer to the backup target braking force calculated by the backup calculation section of each sub-control unit SCU. Namely, when the function of main control unit MCU becomes failed, the drive signal for motor M is produced based on the backup target braking force instead of the target braking force calculated by main control unit MCU. Therefore, the brake-by-wire control can be continued while ensuring the minimum-necessary braking force.

\textcircled{3} In the second embodiment, brake-pedal stroke sensors S/Sen1 and S/Sen2 each serving to sense the pedal stroke representing the amount of brake manipulation, and first and second communications lines (or CAN1 and CAN2) each serving to transmit the sensed values of stroke sensors S/Sen1 and S/Sen2 are provided. Further, four sub-control units SCUFR, SCUFL, SCURR, and SCURL are provided for the corresponding four road wheels. The first communications line (CAN1) is connected with main control unit MCU and sub-control units SCUFR and SCURL provided at front-right and rear-left wheels, and the second communications line (CAN2) is connected with main control unit MCU and sub-control units SCUFL and SCURR provided at front-left and rear-right wheels.

By transmitting the signals of stroke sensors through dual communications lines, even if one of the dual lines becomes down (failed); the calculation of target braking forces in main control unit MCU can be continued, and the backup calculation of target braking forces in two sub-control units SCUs for one pair of diagonally-opposed wheels can be continued. By virtue of such arrangement, even when carrying out a fail-safe control by the brake-by-wire control using only two road-wheels, the braking control securing the stable vehicle behavior can be performed.

\textcircled{4} In the second embodiment, each of main control unit MCU and sub-control unit SCUFR, SCUFL, SCURR, SCURL includes the main microcomputer and the sub-microcomputer to construct a dual system. Therefore, these two microcomputers have a function of monitoring each other, so that fail-safe performance of arithmetic device (microprocessor) is enhanced. Namely, by causing a plurality of combinations of control units to check the difference of target braking controlled variables, it becomes easier to specify the failed part.

\textcircled{5} In the second embodiment, each of sub-control units SCUFR, SCUFL, SCURR, and SCURL is formed integral with the drive circuit for driving motor MFR, MFL, MRR, MRL. Namely, the circuit board integrally including sub-control unit SCU and the drive circuit can be used. Therefore, it is unnecessary to use harnesses for connecting sub-control unit SCU with the drive circuit. Thereby, a downsizing in control system is realized to improve a flexibility in layout.

This application is based on prior Japanese Patent Application No. 2006-233265 filed on Aug. 30, 2006. The entire contents of this Japanese Patent Application are hereby incorporated by reference.

Although the invention has been described above with reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus comprising:
an actuator configured to generate a braking force of road wheel;
a first control unit configured to calculate a target braking controlled variable in accordance with an amount of brake manipulation of a driver; and
a second control unit comprising a backup calculation section configured to calculate a backup target braking controlled variable, by receiving the amount of brake manipulation separately from the first control unit,
the second control unit being configured to select one of the target braking controlled variable and the backup target braking controlled variable in accordance with operating conditions of the first control unit and the second control unit,
the second control unit being configured to output a drive signal to the actuator so as to bring the braking force of road wheel closer to the selected one of the target braking controlled variable and the backup target braking controlled variable.

2. The brake control apparatus as claimed in claim 1, wherein
the second control unit is configured to select the backup target braking controlled variable calculated by the backup calculation section, when the first control unit is failed.

3. The brake control apparatus as claimed in claim 1, wherein
at least one of the first control unit and the second control unit comprises a main microcomputer and a sub-microcomputer to construct a dual system.

4. The brake control apparatus as claimed in claim 1, wherein
the second control unit is configured to determine that one of the first control unit and the second control unit is failed when the difference between the target braking controlled variable and the backup target braking controlled variable is greater than a predetermined value.

5. The brake control apparatus as claimed in claim 1, wherein
the second control unit is formed integral with a drive circuit for driving the actuator.

6. A brake control apparatus comprising:
a master cylinder provided as a first fluid-pressure source;
a first fluid passage adapted to allow a fluid pressure of the master cylinder to be applied via a first changeover valve to front-left and front-right wheel cylinders of a plurality of wheel cylinders;
a second fluid passage connected with a second fluid-pressure source provided independently of the master cylinder, and adapted to apply a fluid pressure produced from the second fluid-pressure source via a second changeover valve directly to at least one of the plurality of wheel cylinders; and
a control unit configured to switch between the fluid-pressure application from the master cylinder to the front-left and front-right wheel cylinders, and the fluid-pressure application from the second fluid-pressure source to the at least one of the plurality of wheel cylinders, by opening/closing the first changeover valve and the second changeover valve,
the control unit comprising
a first control unit configured to calculate a target braking controlled variable for obtaining a desired braking force, in accordance with an amount of brake manipulation of a driver; and
a second control unit configured to calculate a backup target braking controlled variable separately from the first control unit, in accordance with the amount of brake manipulation,
the second control unit being configured to select one of the target braking controlled variable and the backup target braking controlled variable in accordance with operating conditions of the first control unit and the second control unit,
the second control unit being configured to output drive signals to the second fluid-pressure source and the first and second changeover valves, so as to bring a fluid pressure of the at least one of the plurality of wheel cylinders closer to a target fluid pressure based on the selected one of the target braking controlled variable and the backup target braking controlled variable.

7. The brake control apparatus as claimed in claim 6, wherein
the second control unit is configured to select the backup target braking controlled variable calculated by the second control unit, when the first control unit is failed.

8. The brake control apparatus as claimed in claim 6, wherein
the control unit comprises a plurality of second control units;
at least one of the plurality of second control units is connected with at least one of the second fluid-pressure sources and at least one of the second changeover valves, which are associated with a first pair of diagonally-opposed wheels of four wheels; and
at least another of the plurality of second control units is connected with at least another of the second fluid-pressure sources and at least another of the second changeover valves, which are associated with a second pair of diagonally-opposed wheels of the four wheels.

9. The brake control apparatus as claimed in claim 6, wherein
the amount of brake manipulation of the driver is determined from at least one of a sensed value of the fluid pressure inside the master cylinder and a sensed value of a brake-pedal stroke;
the first control unit is configured to calculate the target braking controlled variable based on two of the sensed value of the fluid pressure inside the master cylinder and the sensed value of the brake-pedal stroke; and
the second control unit is configured to calculate the backup target braking controlled variable based on only one of the sensed value of the fluid pressure inside the master cylinder and the sensed value of the brake-pedal stroke.

10. The brake control apparatus as claimed in claim 6, wherein
the second control unit is configured to determine that one of the first control unit and the second control unit is failed when the difference between the target braking controlled variable and the backup target braking controlled variable is greater than a predetermined value.

11. The brake control apparatus as claimed in claim 6, wherein
at least one of the first control unit and the second control unit comprises a main microcomputer and a sub-microcomputer to construct a dual system.

12. The brake control apparatus as claimed in claim 6, wherein
the second control unit is formed integral with a drive circuit for driving the second fluid-pressure source and the first and second changeover valves.

13. The brake control apparatus as claimed in claim 6, wherein
the second fluid-pressure source is a gear pump adapted to be driven by a motor and adapted to supply fluid pressure directly to at least one of the plurality of wheel cylinders.

14. The brake control apparatus as claimed in claim 7, wherein
the second control unit is configured to determine that one of the first control unit and the second control unit is failed when the difference between the target braking controlled variable and the backup target braking controlled variable is greater than a predetermined value.

15. A brake control apparatus comprising:
an electrical caliper provided at a road wheel and configured to be driven by a motor to generate a braking force of the road wheel;
a first control unit configured to calculate a target braking controlled variable in accordance with an amount of brake manipulation of a driver; and
a second control unit configured to calculate a backup target braking controlled variable, by receiving the amount of brake manipulation separately from the first control unit,
the second control unit being configured to select one of the target braking controlled variable and the backup target braking controlled variable in accordance with operating conditions of the first control unit and the second control unit,
the second control unit being configured to output a drive signal to the motor so as to bring the braking force of the road wheel closer to the selected one of the target braking controlled variable and the backup target braking controlled variable.

16. The brake control apparatus as claimed in claim 15, wherein
the second control unit is configured
to determine that one of the first control unit and the second control unit is failed when the difference between the target braking controlled variable and the backup target braking controlled variable is greater than a predetermined value, and
to select the backup target braking controlled variable when determining that the first control unit is failed.

17. The brake control apparatus as claimed in claim 16, wherein
the brake control apparatus further comprises
a brake-pedal stroke sensor adapted to detect the amount of brake manipulation, and
a dual communication lines provided between the first control unit and the brake-pedal stroke sensor to transmit a signal of the brake-pedal stroke sensor to the first control unit;
four second control units are provided for four road wheels of vehicle; and
one of the dual communication lines is connected to two second control units for a first pair of diagonally-opposed wheels of the four wheels, and another of the dual communication lines is connected to two second control units for a second pair of diagonally-opposed wheels of the four wheels.

18. The brake control apparatus as claimed in claim 16, wherein
at least one of the first control unit and the second control unit comprises a main microcomputer and a sub-microcomputer to construct a dual system.

19. The brake control apparatus as claimed in claim 16, wherein
the second control unit is formed integral with a drive circuit for driving the motor.

20. A brake control method comprising the steps of:
calculating a first target braking controlled variable in accordance with an amount of brake manipulation of a driver;
calculating a second target braking controlled variable, by receiving the amount of brake manipulation separately from the calculation of the first target braking controlled variable;
selecting one of the first target braking controlled variable and the second target braking controlled variable, in accordance with properness in the calculations of the first and second target braking controlled variables; and
outputting a drive signal to an actuator that generates a braking force of road wheel, so as to bring the braking force of road wheel closer to the selected one of the first target braking controlled variable and the second target braking controlled variable.
